(19) United States
(12) Patent Application Publication
(10) Pub. No.: US 2013/0179078 A1
(43) Pub. Date: Jul. 11, 2013

(54) METHOD FOR MEASURING WEEKLY AND ANNUAL EMISSIONS OF A GREENHOUSE GAS OVER A GIVEN SURFACE AREA

(71) Applicant: Tanguy Griffon, Geneva (CH)

(72) Inventor: Tanguy Griffon, Geneva (CH)

(21) Appl. No.: 13/512,136

(22) PCT Filed: Nov. 25, 2010
(86) PCT No.: PCT/IB10/55410

§ 371 Date: Aug. 6, 2012

(30) Foreign Application Priority Data
Nov. 26, 2009 (FR) 09 58385

(51) Int. Cl. G01W 1/10

(52) U.S. Cl. CPC G01W 1/10
USPC 702/3

(57) ABSTRACT

Method for measuring weekly and annual emissions of a greenhouse gas generated over a determined geographical area and measuring system implementing the method.

### TECHNICAL FIELD

The invention relates to methods for measuring greenhouse gas emissions (GHGs). The invention relates in particular to a method for measuring weekly and annual emissions of a greenhouse gas over a given geographical area. It also relates to a measuring system allowing the implementation of the method for measuring.

### BACKGROUND

GHGs are those gaseous constituents of the atmosphere, both natural and anthropogenic, that absorb and emit radiation at specific wavelengths within the spectrum of thermal infrared radiation. They are mainly carbon dioxide (CO2), methane (CH4), nitrous oxide (N2O), nitrogen oxides (NOx), hydrofluorocarbons (HFCs), chlorofluorocarbons (CFCs), perfluorocarbons (PFCs), sulphur hexafluoride (SF6), tropospheric ozone (O3), water vapor (H2O), carbon monoxide (CO) and hydrogen (H2). CO2 is generally the reference gas. When they absorb thermal infrared radiation, emitted by the Earth's surface, by the atmosphere and by the clouds, atmospheric radiation is emitted to all sides and downward to the Earth's surface. GHGs differ in their radiative forcing on the climate system due to their different radiative properties and lifetimes in the atmosphere. GHGs trap heat within the surface-troposphere system, which is commonly called the “greenhouse effect,” and an increase in their concentration may lead to an enhancement of this effect with a warming.

Natural sources of CO2 are much more important than anthropogenic sources, but over long periods of time, natural sources are closely balanced by natural sinks. The atmospheric concentration of CO2 has remained between 260 and 280 parts per million (ppm) in the atmosphere since the Holocene, i.e., for the last 10,000 interglacial years, but since the industrial era, human activity has increased its concentration on the order of 100 ppm. The scientific community has recently acknowledged that the greenhouse effect induced from anthropogenic GHGs has produced a positive forcing on surface temperature of about 1° c. above the mean since the middle of the 20th century. It is therefore likely that anthropogenic warming due to elevated GHGs levels has influenced natural physical and biological systems. Expected changes in climate factors are notably to impact freshwater resources, industry, food and health. Stabilization of concentrations at a level that would prevent any dangerous anthropogenic interference with the climate system has therefore become a priority for the international community.

CO2 is the most common form of carbon in the atmosphere, and it is the primary source of carbon in organic matter. It is coming from exchanges between the atmosphere and the biosphere, the atmosphere and the oceans, biosphere disturbances and anthropogenic production. The imbalance between absorption and emission leads to a net increase in the atmosphere.

In the evaluation method called “CarbonTracker”, the law of mass conservation is used to assess the atmospheric flux F_{CO2}(t) assuming that the mass of carbon in the atmosphere is equal to the net effect of all sources and sinks at a given time t. This flux is both the mass exchange by surface area unit as well as the mass exchange on an integrated area in the context of finite areas. One then has:

F_{CO2}(t)=F_{oce}(t)+F_{bio}(t)+F_{ff}(t)+F_{fire}(t)
F_{CO2}(t) is the net CO2 atmospheric accumulation flux
F_{oce}(t) is the net atmosphere/ocean exchanges flux
F_{bio}(t) is the net atmosphere/biosphere exchanges flux
F_{ff}(t) is the net anthropogenic sources flux
F_{fire}(t) is the net flux from sources related to fires

The net atmospheric accumulation flux of CO2 in the atmosphere is generally expressed in petagrams of carbon per year (PgC/year) or GTCO2 per year at regional scales. At a human facility level, the flux is expressed in TCO2/year or in TCO2 equivalent/year by adding to the CO2 emissions, those of the other GHGs as a function of their global warming potential compared to CO2. Due to its long atmospheric lifetime, CO2 concentrations are estimated as quite uniform and their variation contributes to estimate flux exchanges.

During the Holocene, concentrations indicated by Vostok and Taylor Dome ice cores analyses were about 275 ppm, way below current ones. In 2007 and 2008, the mean CO2 concentration in the atmosphere was respectively of about 383.71 ppm and 385.57 ppm according to Mauna Loa observations. With an air molar mass of about 28.84 g·mol⁻¹ and an atmosphere mass of about 5.137×10¹⁸ Kg, 1 ppm of CO2 represents about 2.137 PgC, which enables one to calculate the 2008/2007 global annual net flux of atmospheric accumulation coming from natural and anthropogenic exchanges:

$${F}_{CO {2}_{2008 / 2007}} = \frac{d {C}_{CO 2} ( {t}_{2008 / 2007} )}{d {t}_{2008 / 2007}} \cdot \frac{{M}_{C}}{{M}_{air}} \cdot \frac{{m}_{at m}}{{10}^{6}} \approx 3.97 PgC ( \approx 15 GT CO 2 )$$

The Kyoto Protocol to the UNFCCC (United Nations Framework Convention on Climate Change) entered into force on 16 Feb. 2005 and this international agreement sets binding targets for 37 industrialized countries and the European Community for reducing 002, CH4, N2O, HFCs, PFCs and SF6 emissions by at least 5% below 1990 levels in the 2008 to 2012 commitment period. Countries must meet their targets primarily through national measures and they focus on decreasing demand for emissions-intensive goods and services, on developing low-carbon technologies, on increasing their energy efficiency and on reducing their fossil fuel usage. To verify their targets, emissions are monitored and a reporting is done by countries by submitting annual emission inventories. These national emission inventories are an itemized list of emission estimates of national GHGs sources and sinks and they serve as the basis for setting up efficient mitigation actions as well as to ensure emission trends comply with commitments.

The protocol also offers additional means to countries of meeting their targets such as market-based mechanisms (e.g. European Union Trading Scheme). In these mechanisms, a central authority sets an aggregate cap on all inventory sources and emission permits are then issued to facilities, which are required to hold an equivalent number of permits (or credits) which represent the right to emit a specific amount. The total amount of emissions cannot exceed the cap, thus limiting total emissions to that level. Facilities are also allowed to buy and sell allowances amongst themselves, which aims at stimulating ecological investment and reducing their levels with the best cost-efficiency ratio.

For these new markets to be efficient, participants need confidence in the accuracy of the reported data used for establishing baseline emissions. In parallel, regulatory authorities are also concerned that Monitoring, Reporting, and Verification methods (MRV) of GHGs by facility have a high degree of certainty to demonstrate compliance. These MRV methods are essentially performed through ascending or “bottom-up” calculations and observations of GHGs emissions by facility. Despite their continuous improvement, significant uncertainties remain, in particular on certain source categories where emission factors can be quite variable and the measurement process may lack homogeneity from one facility to another. A goal for uncertainty of results is about 5% according to international and industrial standards and it is recognized that companies may have challenges in achieving that excellence level.

Ascending inventory measurement methods are generally performed via calculation and observation methods for each facility. Calculation methods enable one to determine emission sources by using activity data and are obtained by combining measurement systems and parameters coming from laboratory analyses or standard factors in the following form:

$$CO 2 emissions ( \frac{T CO 2}{year} ) = activity data \cdot emission factor \cdot oxidation factor$$

For combustion emissions, activity data are based on fuel consumption. The fuel quantity used is usually expressed in terms of energy content and emission factor. When a fuel is consumed, only part of carbon is oxidized to CO2 and this is taken into account in the oxidation factor.

$$CO 2 emissioins ( \frac{T CO 2}{year} ) = fuel flow ( T or {Nm}^{3} ) \cdot net calorific value ( \frac{TJ}{T} or \frac{TJ}{{Nm}^{3}} ) \cdot emission factor ( \frac{T CO 2}{TJ} ) \cdot oxidation factor$$

For process emissions, activity data are based on material consumption, throughput or production output and emission factor. The carbon contained in input materials and not converted into CO2 is taken into account in the conversion factor.

$$CO 2 emissions ( \frac{T CO 2}{year} ) = activity data ( T or {Nm}^{3} ) \cdot emissions factor ( \frac{T CO 2}{T} or \frac{T CO 2}{{Nm}^{3}} ) \cdot conversion factor$$

Calculation software based on a facility activity are currently being developed on this same principle.

As for other bottom-up measurement methods by facility, these determine emissions from sources by means of continuous measurement at a representative point of GHGs concentration in the flue gas and flue gas flow. The gas flux Qe is calculated by means of a mass balance approach, taking into account input material loads, input air flow, process efficiency and on the output side, the production output and the GHGs concentrations.

$$CO 2 emissions ( \frac{T CO 2}{year} ) = {\sum }_{i = 1}^{operating hours per year} CO {2}_{{concentration}_{i}} \cdot Q {e}_{i}$$

These bottom-up calculation and measurement methods however need to be performed at each facility and despite their constant improvement, results show some heterogeneity from one facility to another depending on parameters and processes used. They focus on specific facility points and may also omit adjacent sources.

A second type of method for measuring emissions, called top-down, focuses on understanding the carbon cycle to determine carbon sources and sinks at different geographical scales and to calculate, by aggregating fluxes, the local inventories. The CO2 mole fraction (ppm), defined as the number of CO2 moles divided by the total number of moles (except water) in a given air parcel is commonly used as it is a conservative quantity, which does not depend on pressure, temperature, water vapor or condensed water content, which are highly variable. Less variable, it only depends on exchanges between CO2 sources and sinks, almost all of which are caused by surface processes. It reflects the sum of all CO2 exchanges and forms the ultimate result of the combined human and natural influences.

In this approach, the CarbonTracker is an international reference used to better understand the variability of the natural carbon cycle and to estimate the natural and human contributions. It estimates CO2 atmospheric exchanges by combining modeling and observation and its principle is similar to other data assimilation systems. It starts by forecasting atmospheric CO2 mole fractions on the globe from a combination of exchange models (ocean module, biosphere module, fire module and fossil module) with an atmospheric transport model driven by meteorological forecasts. The CO2 distribution in 3D is then sampled at the time and location that observations are available, and the difference between observations and model forecast is minimized with an ensemble data assimilation. This minimization is achieved by tuning a set of linear reduction factors that control the surface fluxes magnitude to obtain optimized final fluxes of 1°×1° resolution for North America and Europe.

A measurement that is “descending” or “top-down”, accurate, in-situ and independent of GHGs natural sources and sinks assessing on a planetary scale up to locally the GHGs inventories of facilities can complement and correlate current ascending methods. It can help confirm that current mitigation actions undertaken by countries and facilities efficiently reduce levels and strengthen trust and credibility in emission markets as well as in the value of polluting rights when in the current context, the price of carbon remains relatively volatile and concentration levels are historically high.

### INVENTION SUMMARY

A first purpose of the invention is to provide a method for measuring net GHGs inventories by geographical area and/or facility, corrected from interferences with adjacent or distant areas. The present invention proposes an improved method for measuring, compared to the CarbonTracker to assess with accuracy the GHGs inventories by geographical area, in particular by geographical area representative of an anthropogenic facility, notably the inventories of CO2, but also those of CH4, N2O, NOx, HCFC, HFC, CFC, PFCS, SF6, O3, H2O, CO and H2. The method is initially presented for CO2 and the same process is used for the other GHGs.

A first advantage of the invention is to provide a method for measuring the emissions of a greenhouse gas more accurate than the current measurement methods, in particular more accurate than the Carbontracker. In particular, a first characteristic of the invention is to resolve smaller spatial scales to obtain the net anthropogenic fluxes, notably of CO2, in Kg/m2/s measured from the world scale up to the level of the emitting facilities with a resolution of 0.1°×0.1° (≈100 km2). With the fluxes measurement of other GHGs, one purpose of the method for measuring according to the invention is therefore to determine, for areas that can be between 1 km2 and 10,000 km2, the emissions in (TCO2/year), (TGHGs/year) and (TCO2 eq/year) with an accuracy above 5%. With such an accuracy, this descending, uniform and global measurement of GHGs inventories has advantages in comparing results for all facilities to verify inconsistencies, avoid source omissions, reduce uncertainty by facility and complement current bottom-up assessments. In summary, the first purpose of the method for measuring according to the invention is therefore to provide a method for measuring enabling one to measure, from top to bottom, on a planetary scale up to the facility level, the GHGs inventories in order to provide an accurate measurement of emissions.

A second purpose of the invention is to provide a measuring system for GHGs emissions which can be combined, notably with the production management systems of facilities, to enable the control of facilities in order to limit combustion and/or process emissions and automate their reduction. Specific hardware and software means implementing the method for measuring according to the invention and ensuring interfacing with the production management systems are installed within the emitting facilities depending on their activity (energy, industrial processes, product uses . . . ), the processes implemented by them and the GHGs emitted. The measuring system according to the invention can then be used to calibrate and to optimize the process of each facility, depending on the levels and the types of emissions measured (ex: pollution peaks). This enables one to obtain an automated emission reduction at each facility, to progressively control its effectiveness and to remain in compliance with the regulatory and environmental standards.

A second purpose of the invention is therefore to provide a measuring system that can directly be interfaced within an emitting facility in order to optimize the production processes while setting up various mitigation processes or techniques, thus enabling one to calibrate the facilities while controlling and optimizing the emission levels based on the measurements performed.

According to the invention, the method for measuring weekly and annual emissions of a greenhouse gas generated over a determined geographical area comprises the following steps:
perform daily concentration measurements of said greenhouse gas in a first plurality of locations distributed on the entire terrestrial globe and save said daily concentration measurements in an observation module,
perform daily flux measurements of said greenhouse gas in a second plurality of locations distributed on the entire globe, and save the said daily flux measurements in said observation module,
perform measurements of satellite parameters, meteorological parameters, marine parameters and ecosystem parameters in a third plurality of locations distributed on the terrestrial globe and save said parameter measurements in the said observation module,
extract, by means of an extraction module, the weather forecast data from at least one data source,
perform a flux evolution modeling of the said gas on the globe by means of an exchange module modeling the natural and anthropogenic sources and sinks,
perform a weekly anthropogenic emissions modeling of said greenhouse gas by means of an ascending inventories module, said module integrating the raw data of emissions for a plurality of facilities,
perform, using said flux evolution modeling, said weekly anthropogenic emissions modeling, and said weather forecast data, an atmospheric transport modeling of the said greenhouse gas by means of a transport module,
calculate the final fluxes of said greenhouse gas, by means of a data inversion and assimilation module using said fluxes modeling performed by the exchange module, said weekly anthropogenic emissions modeling performed by the ascending inventories module, said atmospheric transport modeling performed by the transport module and said measurements saved in said observation module,
weight, by means of a weighting module, the said final fluxes so as to provide final weighted fluxes,
calculate, using said final weighted fluxes and said weekly anthropogenic emissions modeling performed by the ascending inventories module, the weekly emissions of said greenhouse gas of said geographical area, by means of a geocoding module comprising at least one geographic information system,
extrapolate, from said weekly emissions, the annual emissions of said greenhouse gas of the said geographical area.

First and foremost, it is appropriate to establish that in the meaning of the present invention and throughout the following description, it is appropriate to interpret the word “module” in the computer science sense of the term. Indeed, all modules of the method for measuring according to the present invention, and notably the observation module, are, preferably, implemented in the form of software, hardware or a combination of both. Each module of the method can advantageously, depending on its role, be implemented using computer equipment means, notably means of calculation (computers, dedicated servers, mainframes, etc), communication systems (WAN, LAN, INTERNET), but also software, notably database management systems, modeling software, calculation software etc. The method for measuring can also be implemented in the form of a single software package, possibly accessible online via the Internet.

Initialization of the method therefore begins with taking daily concentration measurements of the greenhouse gas being considered in a first plurality of locations distributed on the entire terrestrial globe and by the saving of these measurements in an observation module.

There is also a second stage during which one performs daily flux measurements of the greenhouse gas being considered in a second plurality of locations distributed on the entire globe, measurements which are also logged in the observation module. In a third step, one performs measurements of satellite parameters, meteorological parameters, marine parameters and ecosystem parameters in a third plurality of locations distributed on the terrestrial globe and one also logs these measurements of parameters in the observation module. The fourth step of the method consists in then extracting, by means of an extraction module, enabling an automated data transfer, weather forecasts from at least one data source.

Measurements performed during the first three steps of the method are performed by means of a plurality of satellites, aircraft, atmospheric measurements stations, marine measurement stations, ships and/or ecosystem measurement stations which enable one to perform measurements in distinctive locations distributed over the entire globe as will be described in more details subsequently. In addition, the means of measurements can also comprise sensors, marine sensors, ecosystem sensors, etc. The said first, second and third pluralities of locations can therefore overlap to a large extent depending on the local measurement equipment.

The next step in the method for measuring according to the invention consists in the use of an exchange module modeling the flux evolution of the gas in question on the globe by modeling the natural and anthropogenic sources and sinks.

Then, an ascending inventories module is used to model the emission inventories of countries and facilities on a 1°×1° scale, with their seasonality, in Kg/m2/week.

The step that follows consists of an atmospheric transport modeling of the greenhouse gas being considered, this modeling being performed by means of a transport module, on the basis of the flux evolution modeling performed by means of the exchange module, on the basis of the said weekly emissions modeling performed by means of the ascending inventories module and on the basis of the weather forecast data. One then obtains a current distribution of atmospheric molar fractions of CO2 and other GHGs on the globe, which are compared with the data saved in the observation module as will be described in more detail below.

The next step in the method for measuring according to the invention consists in the use of a data inversion and assimilation module, initialized with the results calibrated from the Holocene provided by the exchange module, the results provided by the ascending inventories module and the transport module. The observations and the ascending inventories are integrated in this module and the CO2 atmospheric distribution is sampled at the time and locations where the observations of atmospheric molar fractions are available. The modeled natural and anthropogenic fluxes are scaled using scalar factors in order to correct the fluxes based on the real observations to obtain the final fluxes in Kg/m2/week on 1°×1° grids.

During the next step, a weighting module enables one to determine the final weighted fluxes, using a modeling of production activities and of the emissions market, and to validate the results provided by the data inversion and assimilation module on continental, regional and national scales.

The next step consists in the use of a geocoding module comprising a geographic information system, enabling to correct the ascending inventories on the basis of the said final weighted fluxes in order to obtain the weekly emissions on 0.1°×0.1° grids in Kg/m2/week.

During the final step, based on the weekly emissions, one can then extrapolate the annual emissions on 0.1°×0.1° grids in TCO2/year, TGHGs/year and TCO2 eq/year with an accuracy above 5% of emissions in TCO2/year, TGHGs/year and TCO2 eq/year.

The method for measuring according to the invention therefore samples inventories with a descending approach in the following order: planet, continents, continental regions, states/countries, local regions, down to emitting facilities. The different steps enable the verification at each geographical level of total anthropogenic inventories and to reduce the uncertainties coming from omission of sources and sinks, from emission factors or from lateral fluxes.

According to the invention, the surface of the said geographical area can be between 1 km2 and 10,000 km2, in particular that said geographical area can include at least one given anthropogenic source.

According to the invention, the said greenhouse gas can be selected from the group consisting of: carbon dioxide (CO2), methane (CH4), nitrous oxide (N2O), nitrogen oxides (NOx), hydrofluorocarbons (HFC), hydrochlorofluorocarbons (HCFC), chlorofluorocarbons (CFC), perfluorocarbons (PFC), sulfur hexafluoride (SF6), ozone (O3), water vapor (H2O), carbon monoxide (CO) and dihydrogen (H2).

According to the invention, the said daily concentration measurements of said greenhouse gas on the globe, said daily flux measurements of the said greenhouse gas on the globe, said measurements of satellite parameters, meteorological parameters, marine parameters and ecosystem parameters can be performed by means of a plurality of satellites, aircraft, atmospheric measurement stations, marine measurement stations, ships and/or ecosystem measurement stations enabling one to perform measurements on the entire globe.

According to the invention, the said exchange module can perform the said flux evolution modeling of the said greenhouse gas, from the Holocene, using a solar module modeling the solar radiation using the orbital parameters of the terrestrial geometry with a calculation of the eccentricity of the Earth determined proportionally to the eccentricity of Mars.

According to the invention, the said exchange module can perform said flux evolution modeling of said greenhouse gas, from the Holocene, using an energy module modeling the shortwave radiation, by including reflectivity, absorptivity and transmissivity of the atmosphere, absorption by the greenhouse gases and clouds, variations of planetary albedo and influence of the ozone layer hole, the said energy module modeling also the longwave radiation, using the Schwartzschild equation, the method of the emissivities and including the absorption and emission by the greenhouse gases and the clouds of longwave radiation, latent heat fluxes, sensible heat fluxes, conduction fluxes and surface temperature.

According to the invention, the said exchange module can perform said flux evolution modeling of said greenhouse gas, from the Holocene, using an ocean module modeling the net effect of atmosphere-ocean exchanges on the basis of the MOM3 model combined with said weather forecast data and taking into account the buffer effect, the absorption by chemical weathering following the CDIAC DB1012 model and the release by evaporation.

According to the invention, the said exchange module can perform the flux evolution modeling of said greenhouse gas, from the Holocene, using a biosphere module modeling the net effect of atmosphere-biosphere exchanges on the basis of the JSBACH model and including the plant types of the biosphere, the leaf area index, the light, the albedo, the C3 and C4 photosynthesis, the addition of the limited gross photosynthetic rate, autotrophic respiration, heterotrophic respiration and/or anthropogenic modification of the land cover since at least the last millennium.

According to the invention, the said biosphere module can use a fire module modeling the disturbances due to fires on the basis of the data extracted from the Global Fire Emission Database (GFEDv2) integrated in the JSBACH model.

According to the invention, the said exchange module can perform said flux evolution modeling of said greenhouse gas, from the Holocene, using a fossil module modeling the fossil anthropogenic emissions on a global scale on the basis of the oil and coal production statistics of the Energy Information Administration (EIA) and the estimates of Etemad et al.

According to the invention, the said ascending inventories module can extract emission inventories from the EDGAR 4.0 database and includes a calculation of the temporal variability of emissions.

According to the invention, the said atmospheric transport module can use the TM5 transport model combined with said weather forecast data to calculate the flux atmospheric transport of said greenhouse gas on the globe.

According to the invention, the said data inversion and assimilation module can use, to calculate said final fluxes, a synthesis inversion with the Green function for the large regions and the ensemble Kalman filter.

According to the invention, the said weighting module can use, to weight the said final fluxes, an analysis of the production activities of countries and regions of the world together with a modeling of emission markets based on the model of privately produced public goods.

According to the invention, the said geocoding module can use correcting coefficients.

The measuring system according to the invention, implementing the method for measuring as described above, comprises:
means for measuring concentrations and fluxes of greenhouse gases,
means for measuring satellite, meteorological, marine and ecosystem parameters,
at least one centralized database comprising an observation module,
means for extracting and transferring automated data,
means for calculating comprising at least one exchange module, at least one ascending inventories module, at least one transport module, at least one data inversion and assimilation module, and at least one weighting module,
at least one geocoding module comprising a geographic information system enabling one to geocode the results provided by the said means for calculating,
one centralized Internet platform enabling one to view and analyze the greenhouse gas emissions of a plurality of given geographical areas.

According to the invention, the measuring system can comprise hardware and software means for interfacing with a production management system of a facility.

The invention will be better understood by a person skilled in the art thanks to the detailed description of execution modes in relation with the accompanying drawings, in which:

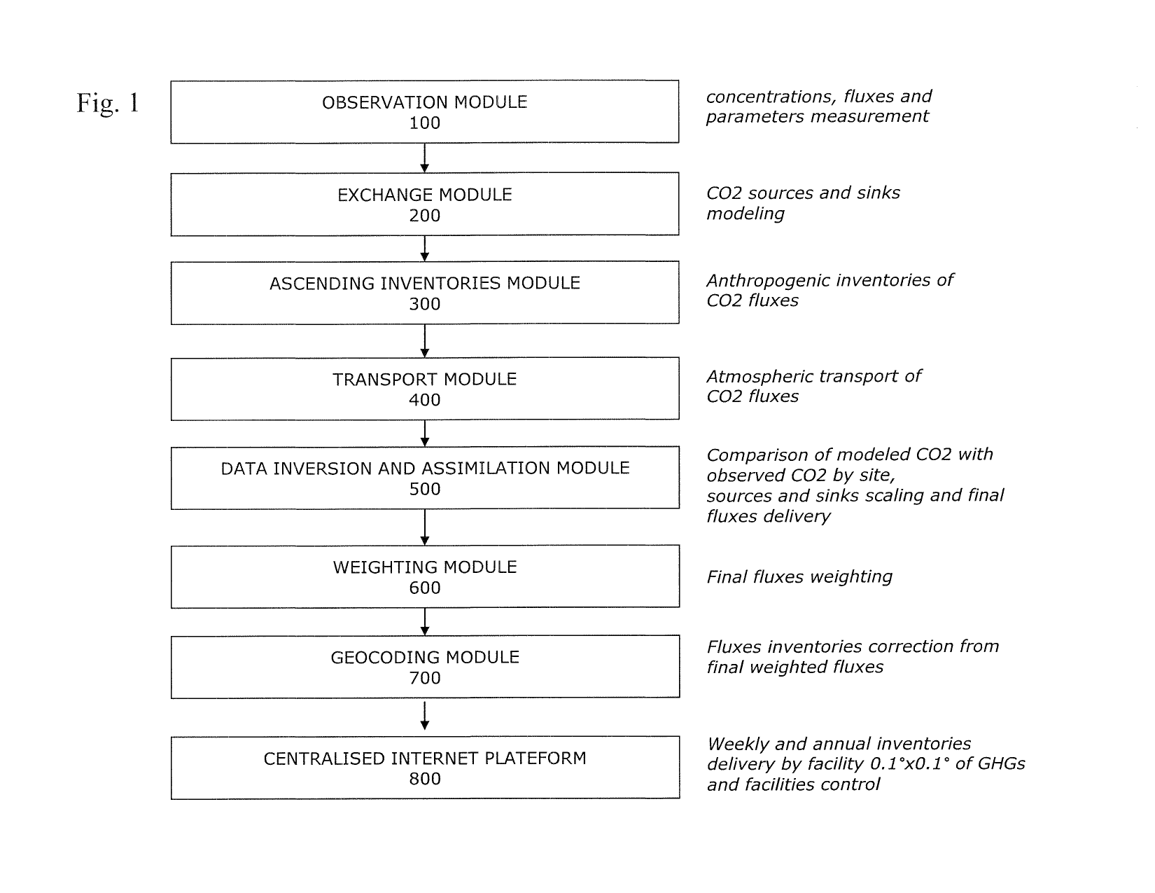

FIG. 1 is a block diagram illustrating the process and components of the method,

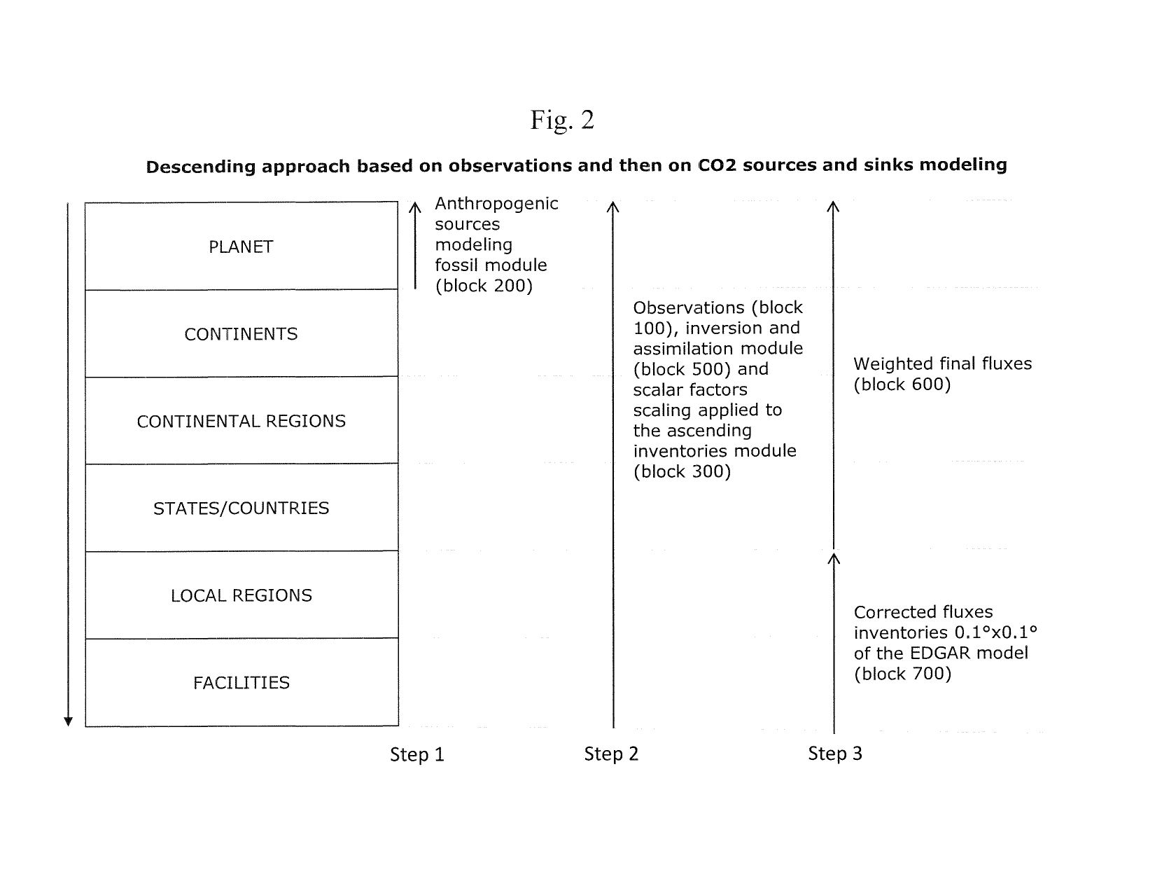

FIG. 2 is a block diagram illustrating the CO2 anthropogenic flux sampling,

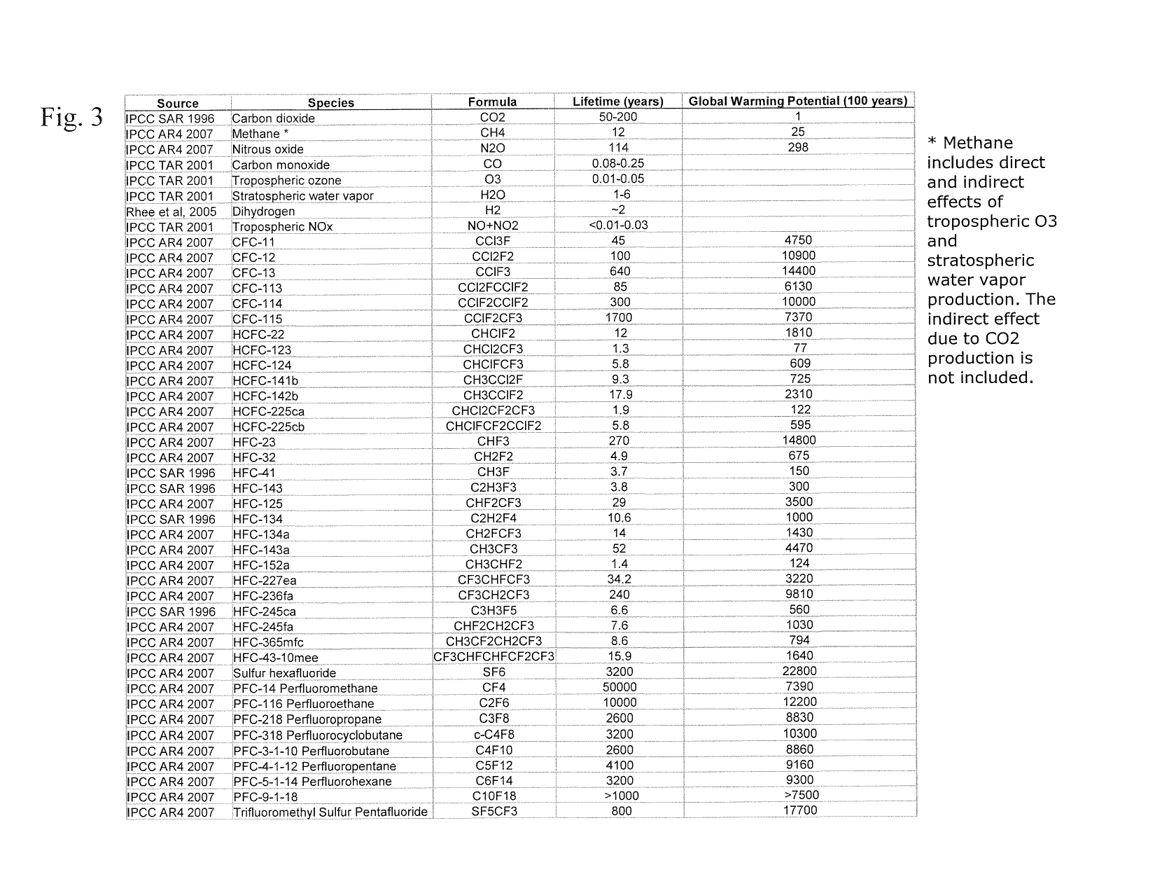

FIG. 3 is a table illustrating the lifetime and global warming potential of GHGs,

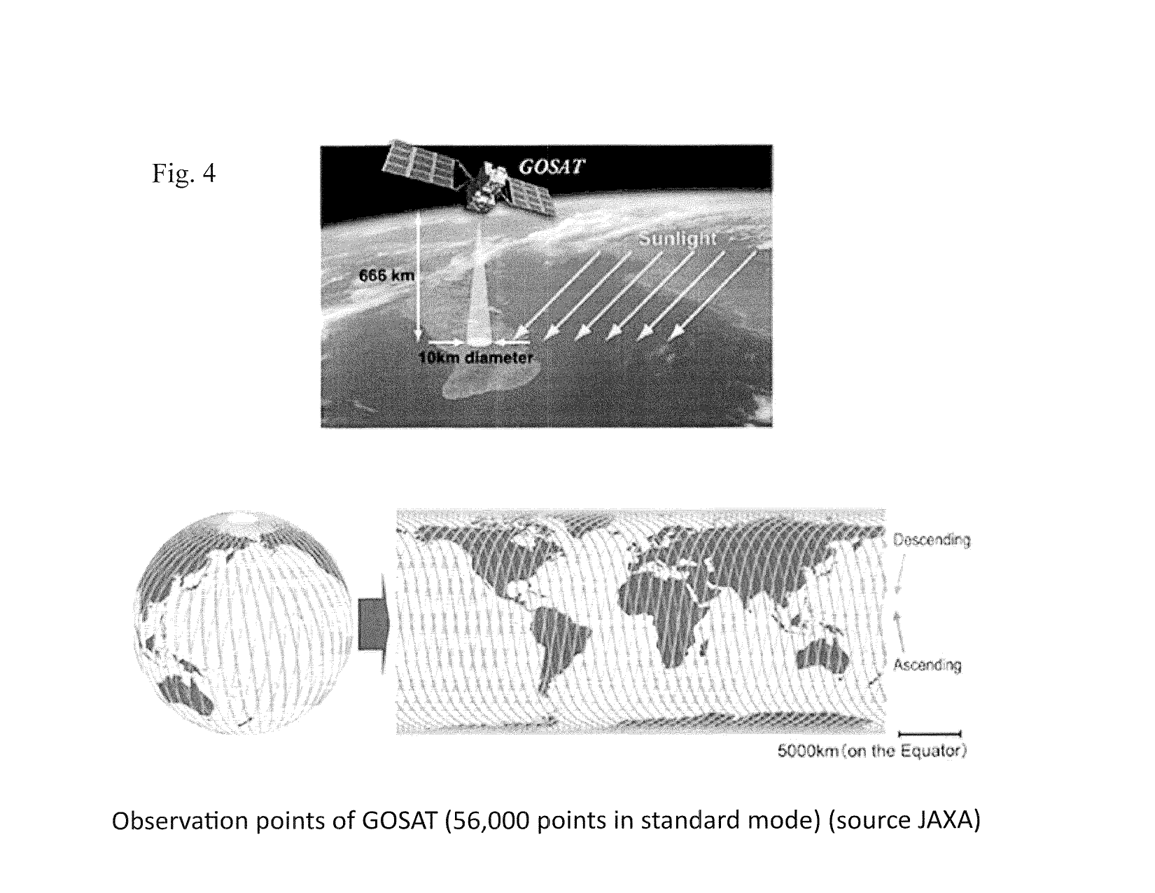

FIG. 4 is a conceptual sampling diagram of the GOSAT satellite,

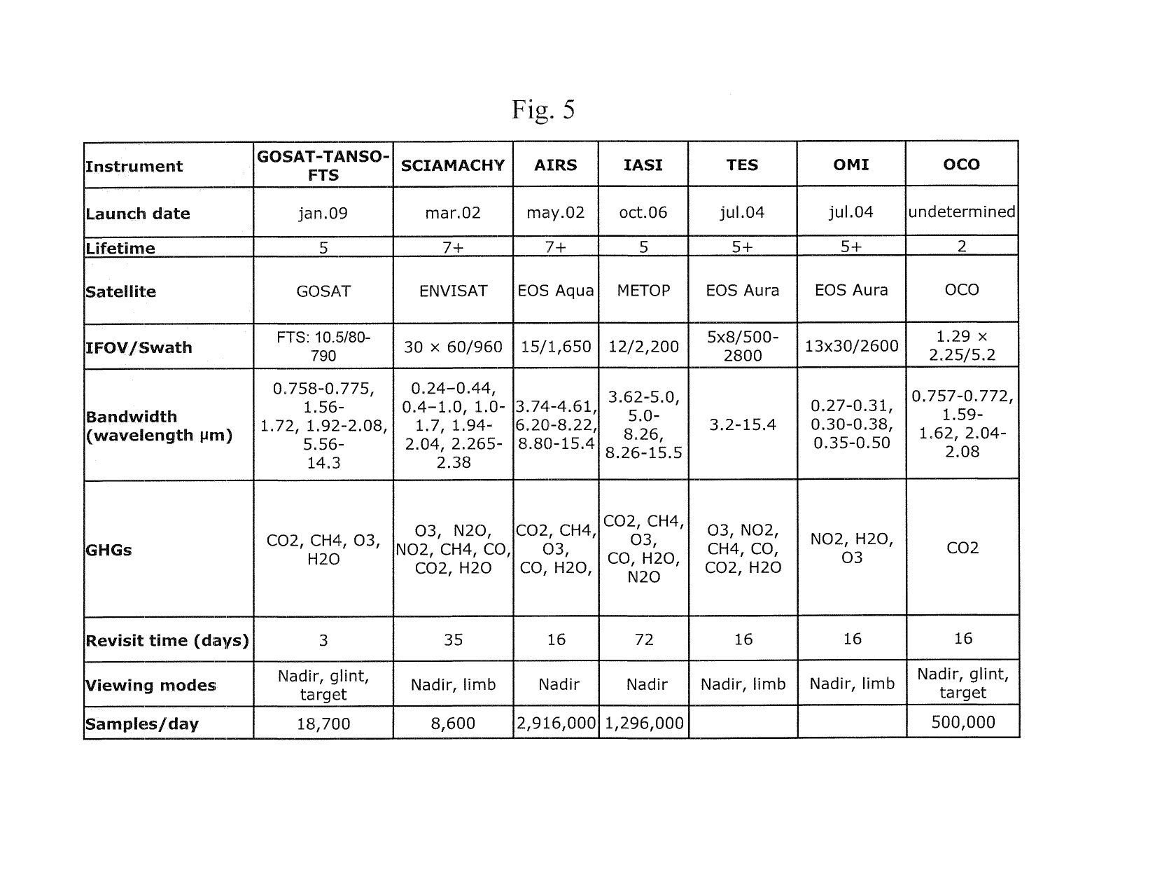

FIG. 5 shows characteristics of satellite observations,

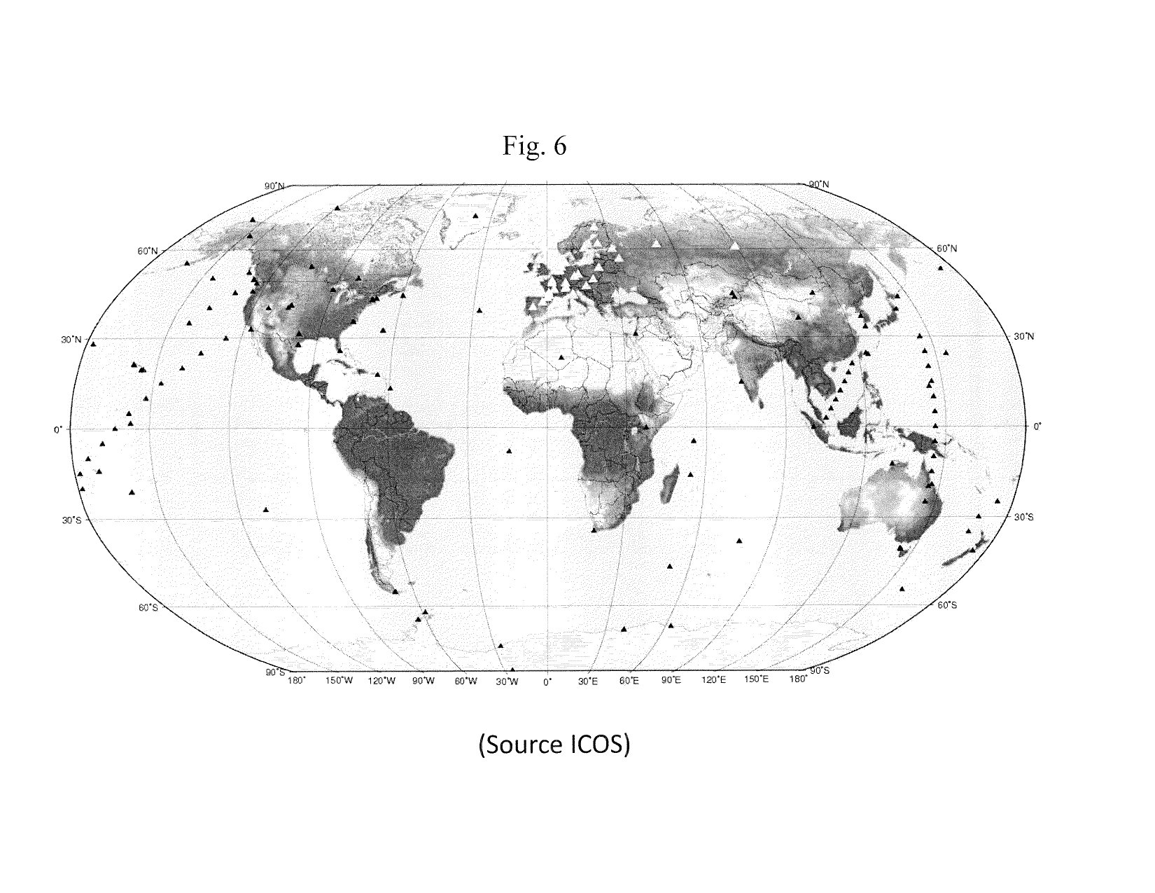

FIG. 6 represents atmospheric observation sites,

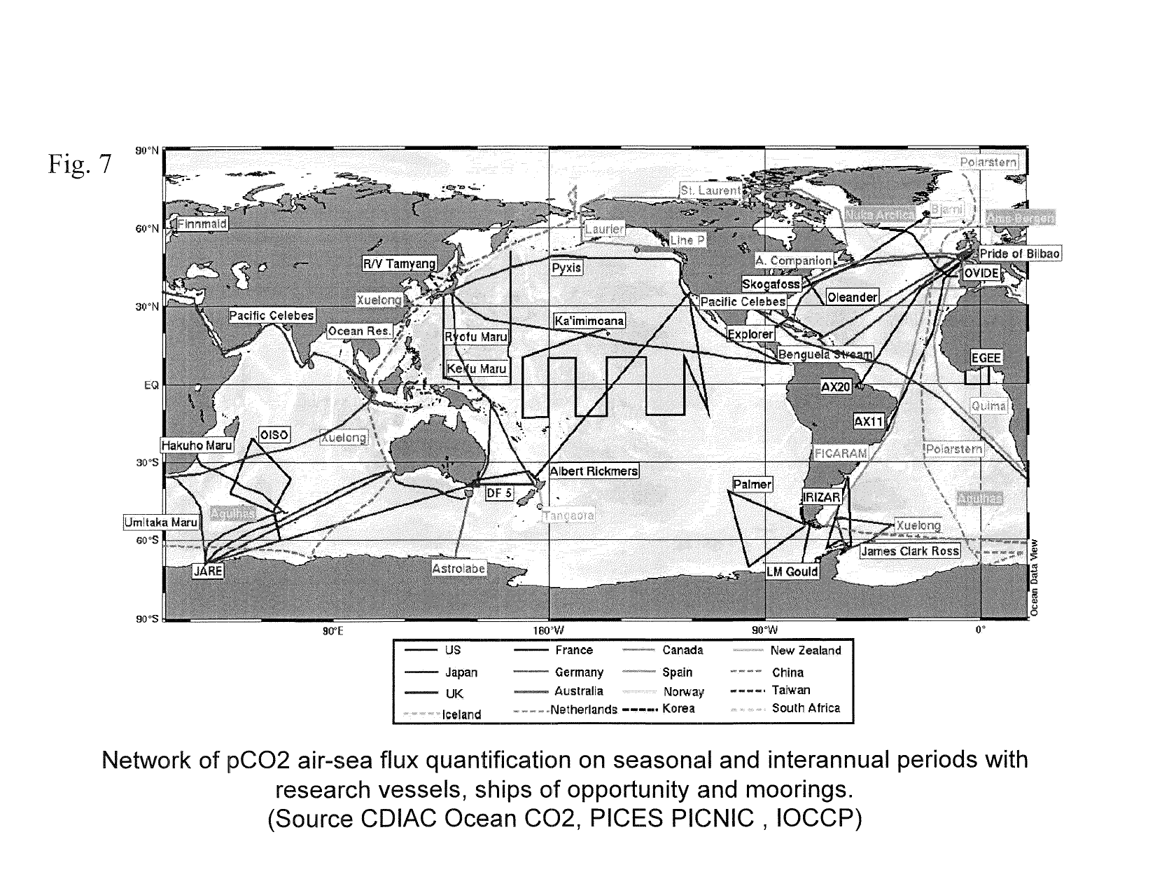

FIG. 7 represents the oceanic measurement network of surface pCO2,

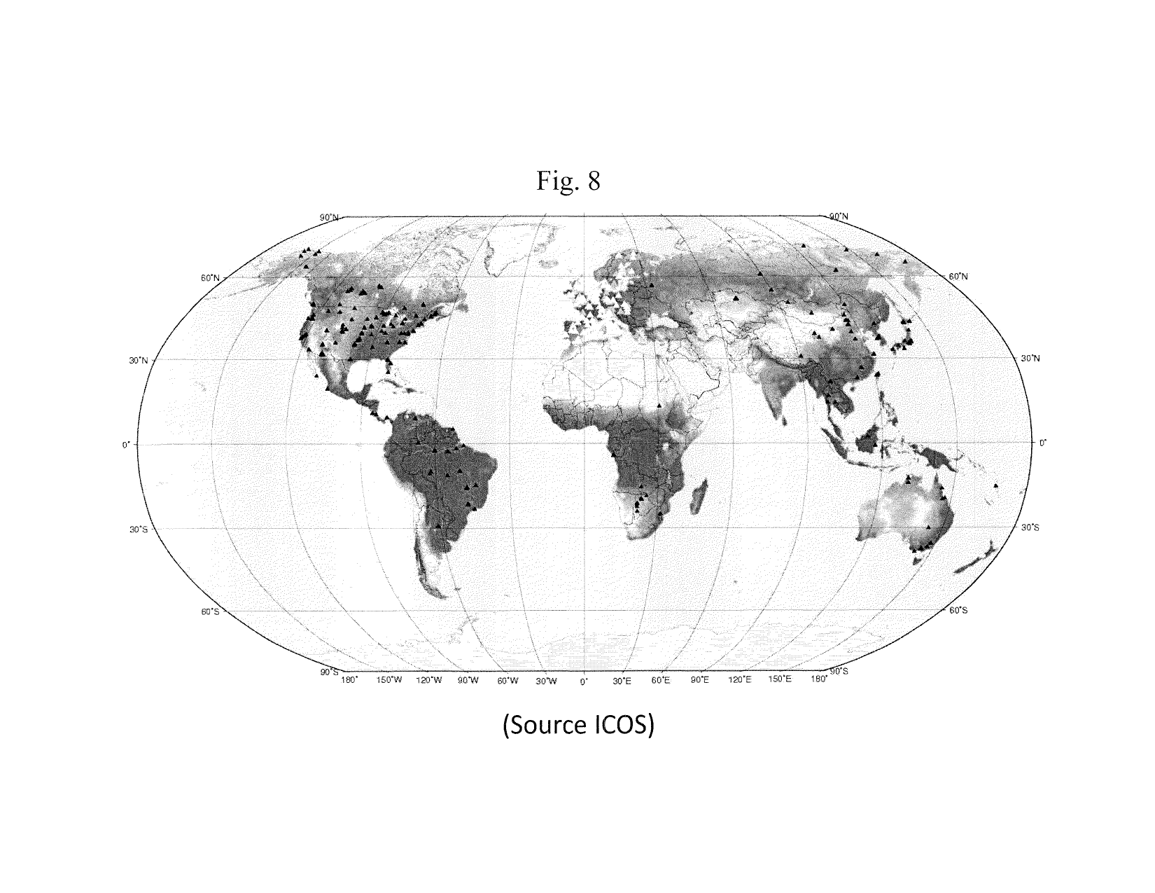

FIG. 8 presents ecosystem observation sites,

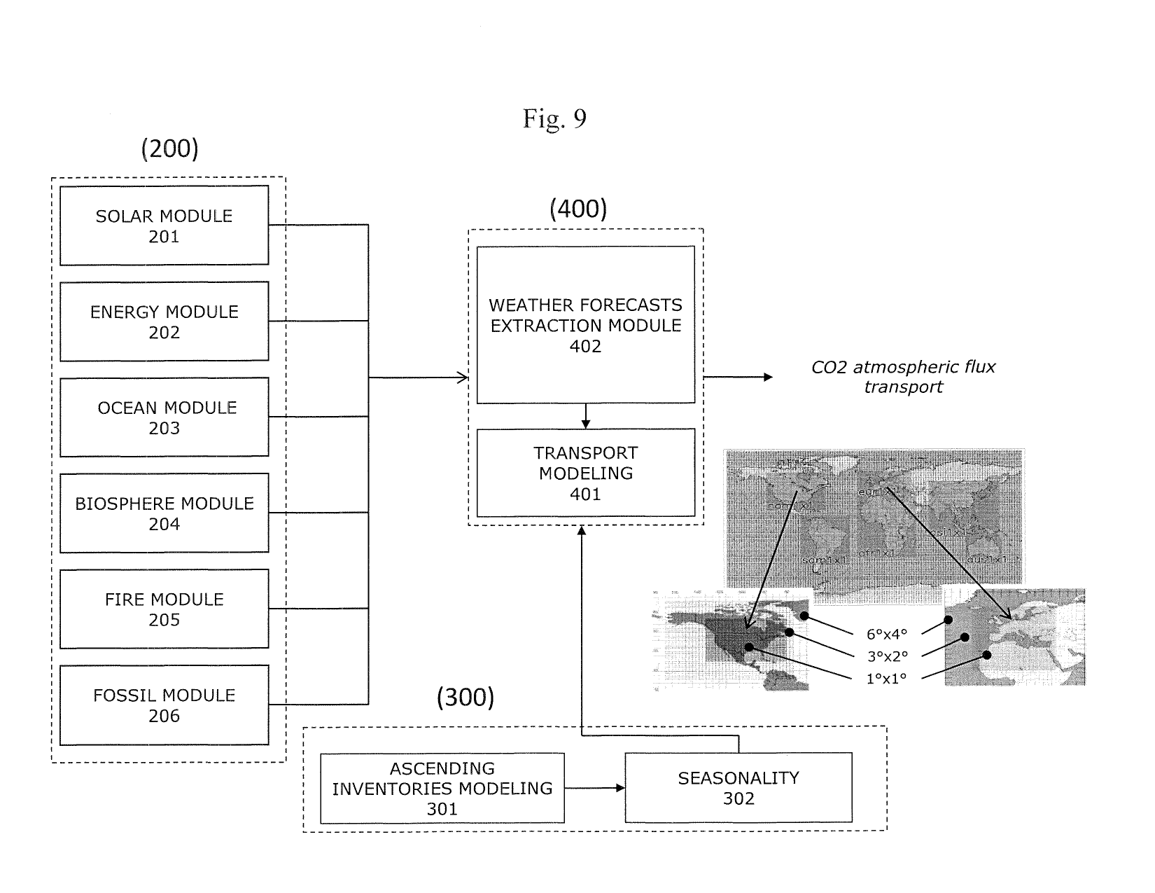

FIG. 9 presents a block diagram illustrating the exchange module, the ascending inventories module and the transport module,

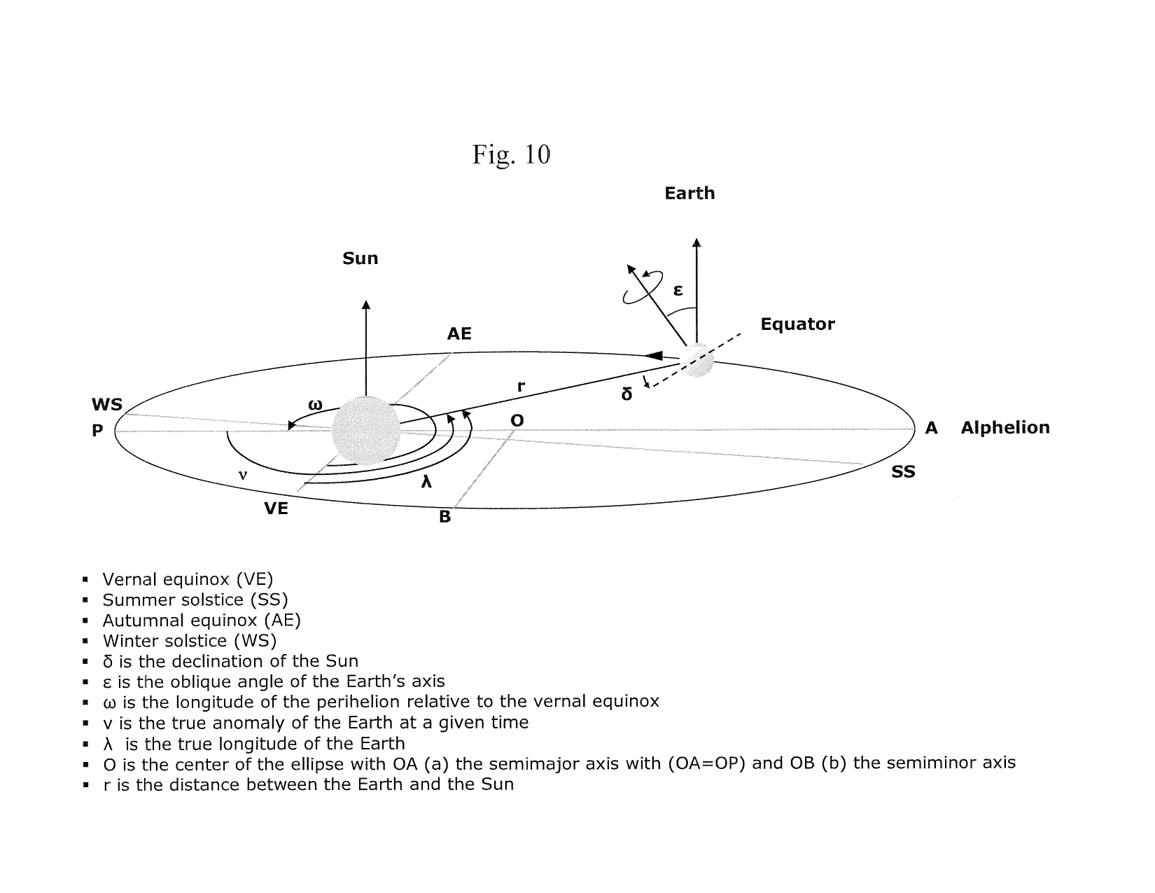

FIG. 10 presents a diagram illustrating the terrestrial orbit around the sun,

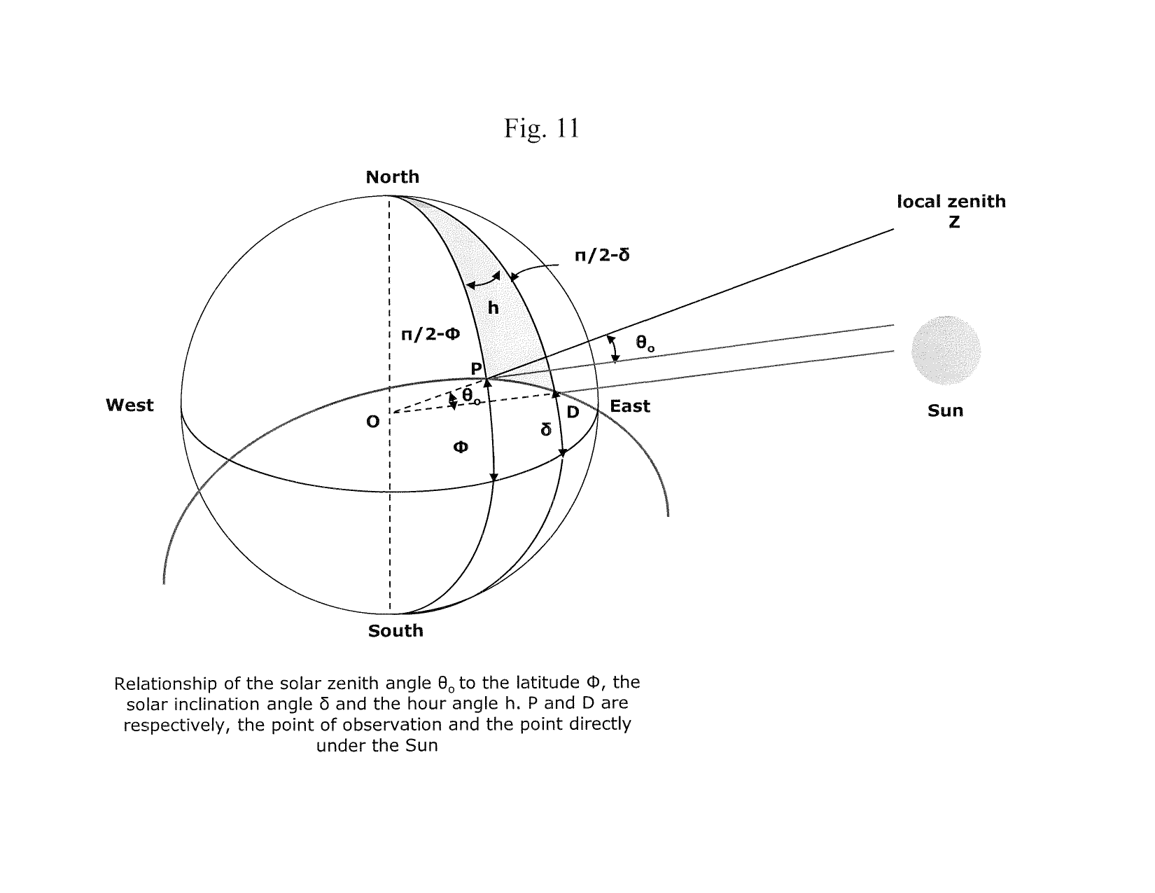

FIG. 11 represents a diagram illustrating the solar radiation at the top of the atmosphere,

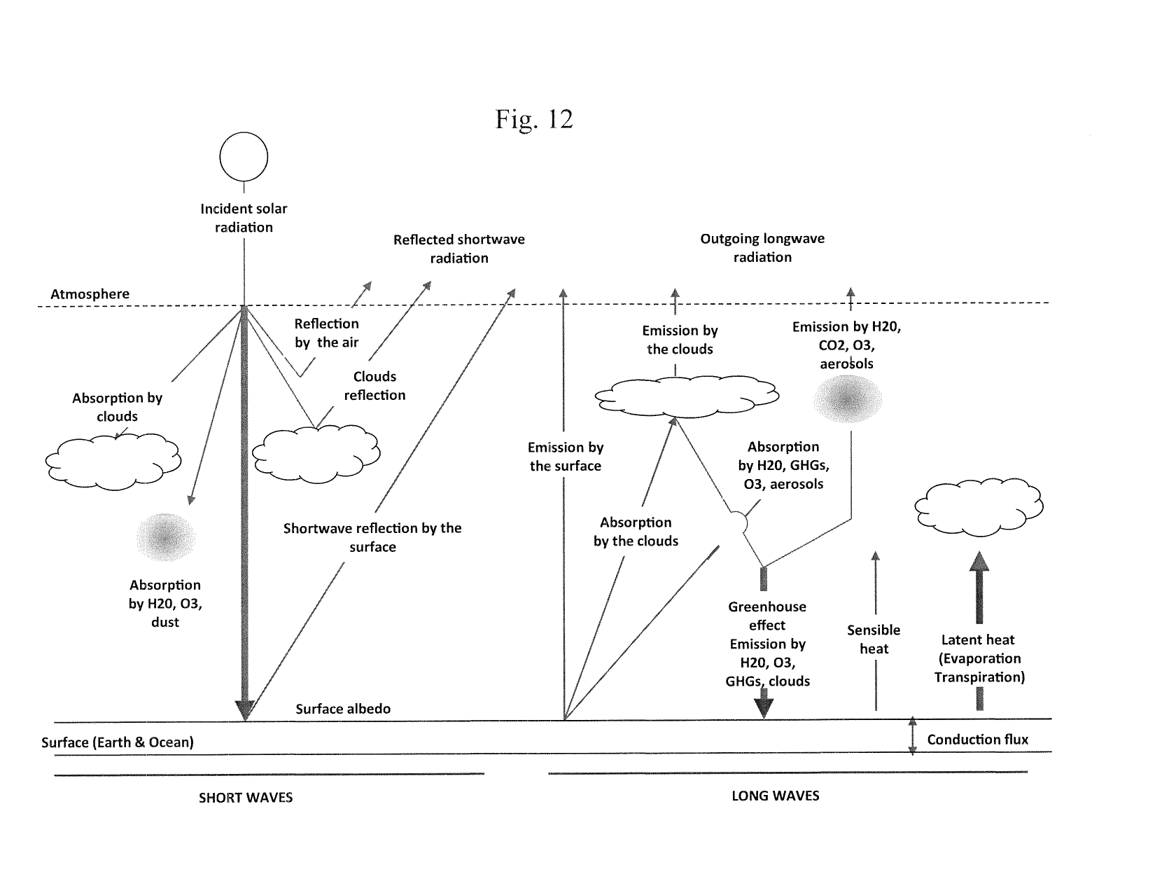

FIG. 12 presents a figure illustrating the energy module,

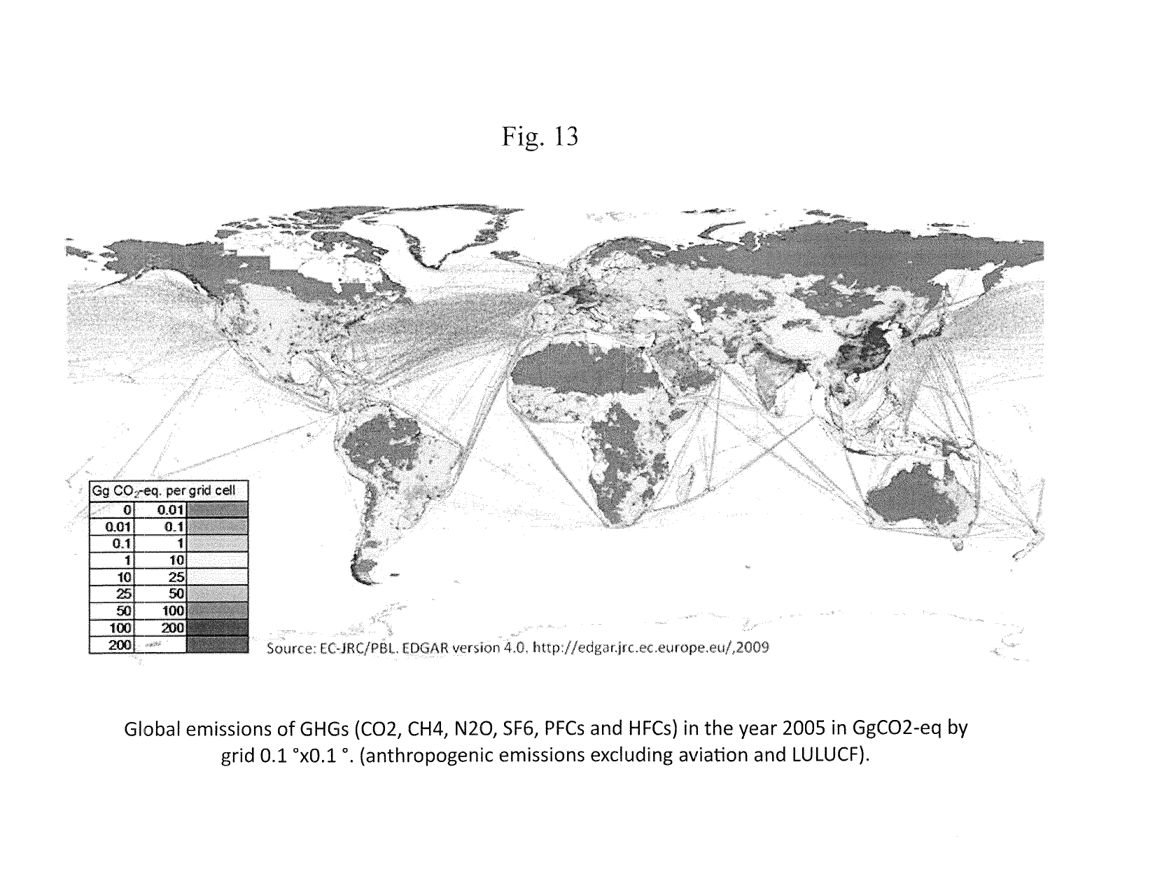

FIG. 13 presents the EDGAR 4.0 inventories on 0.1°×0.1° grids in TCO2 eq,

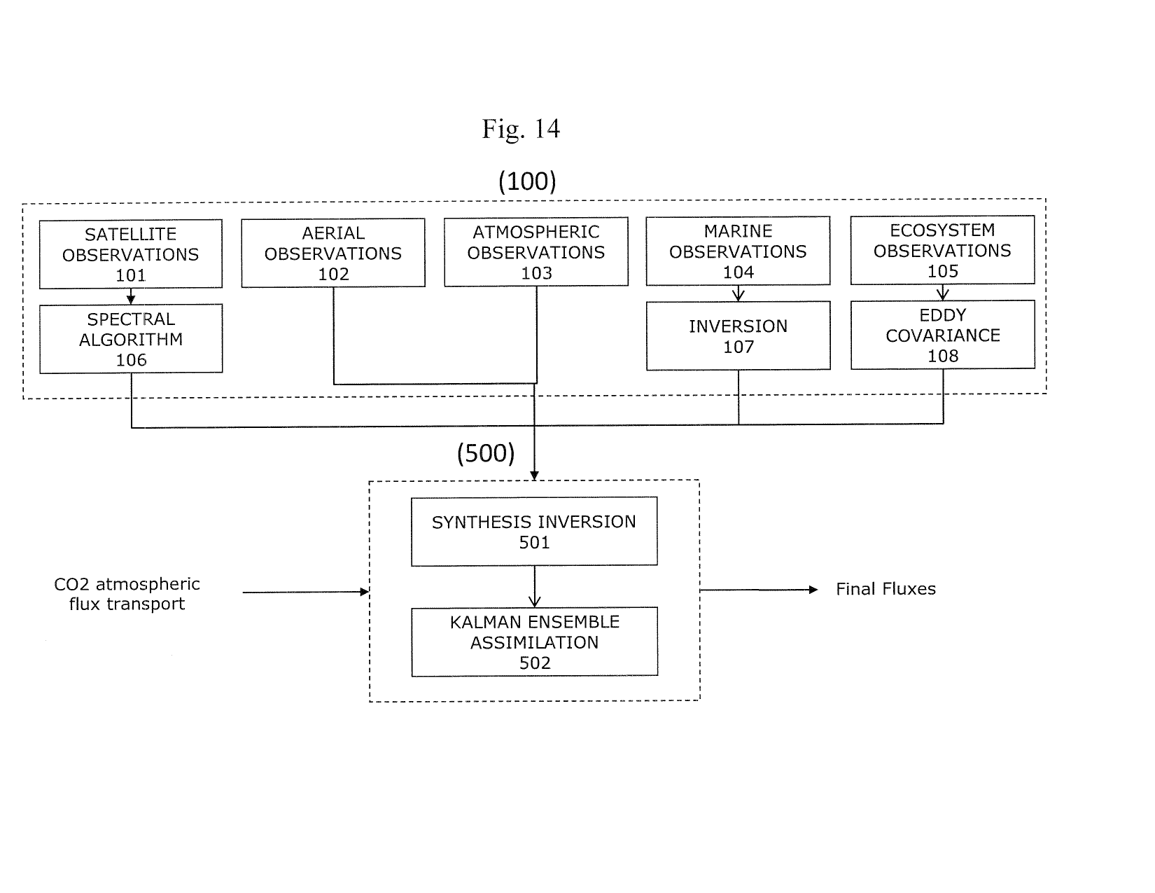

FIG. 14 presents a block diagram illustrating the observation module and the data inversion and assimilation module,

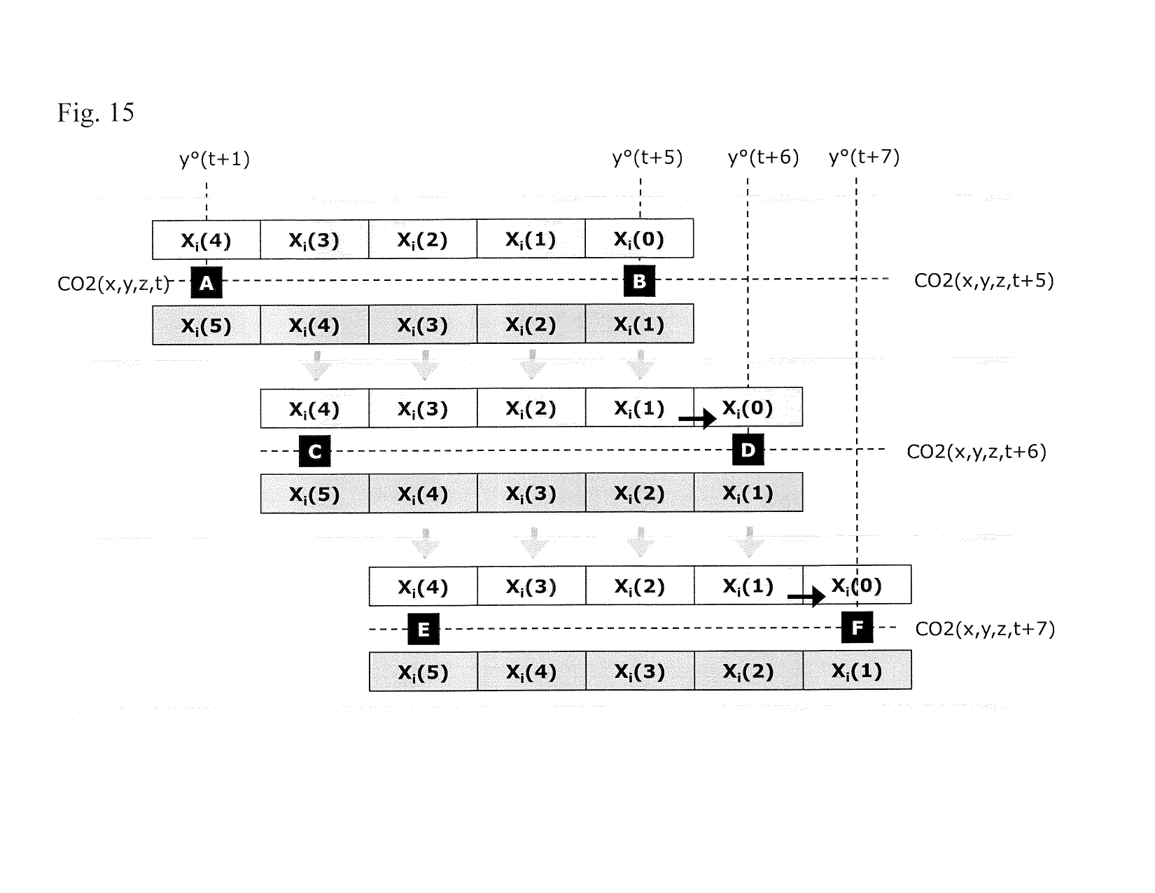

FIG. 15 presents a diagram presenting three data assimilation cycles,

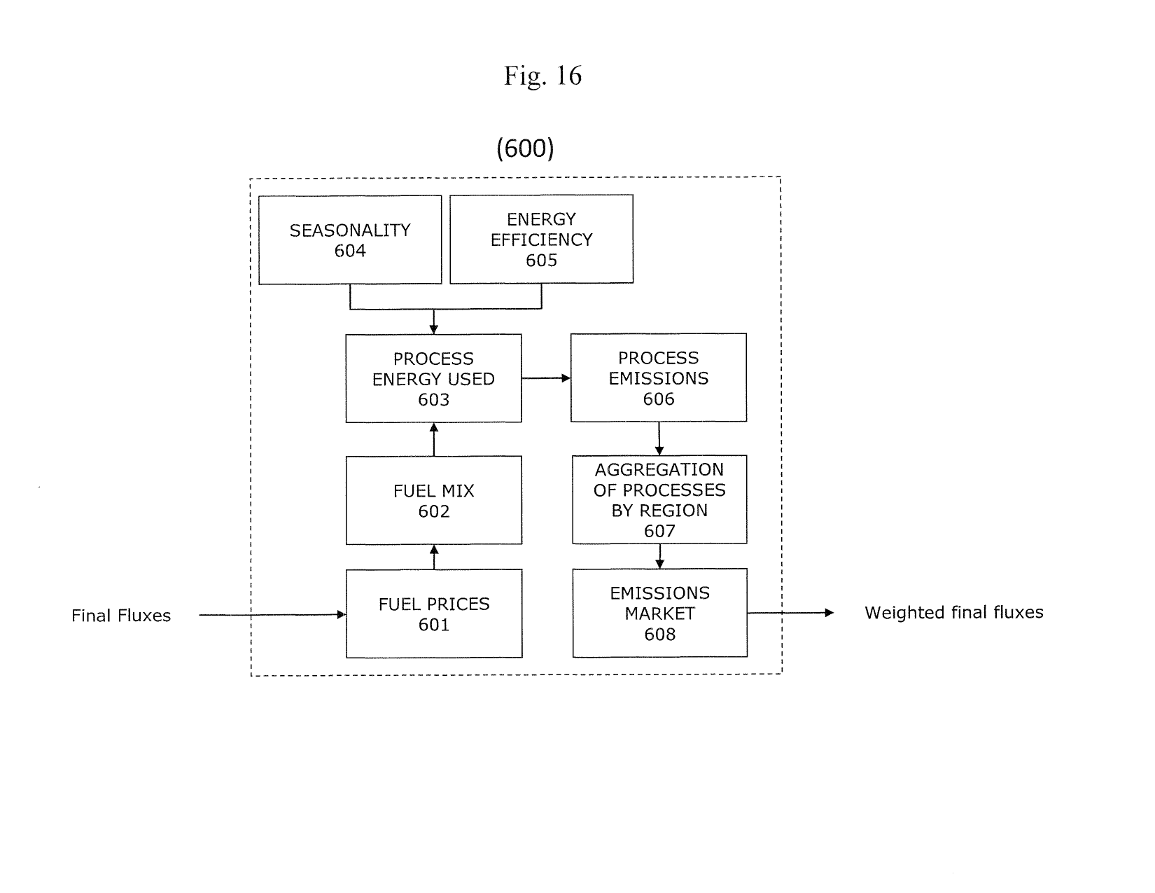

FIG. 16 presents a block diagram illustrating the weighting module,

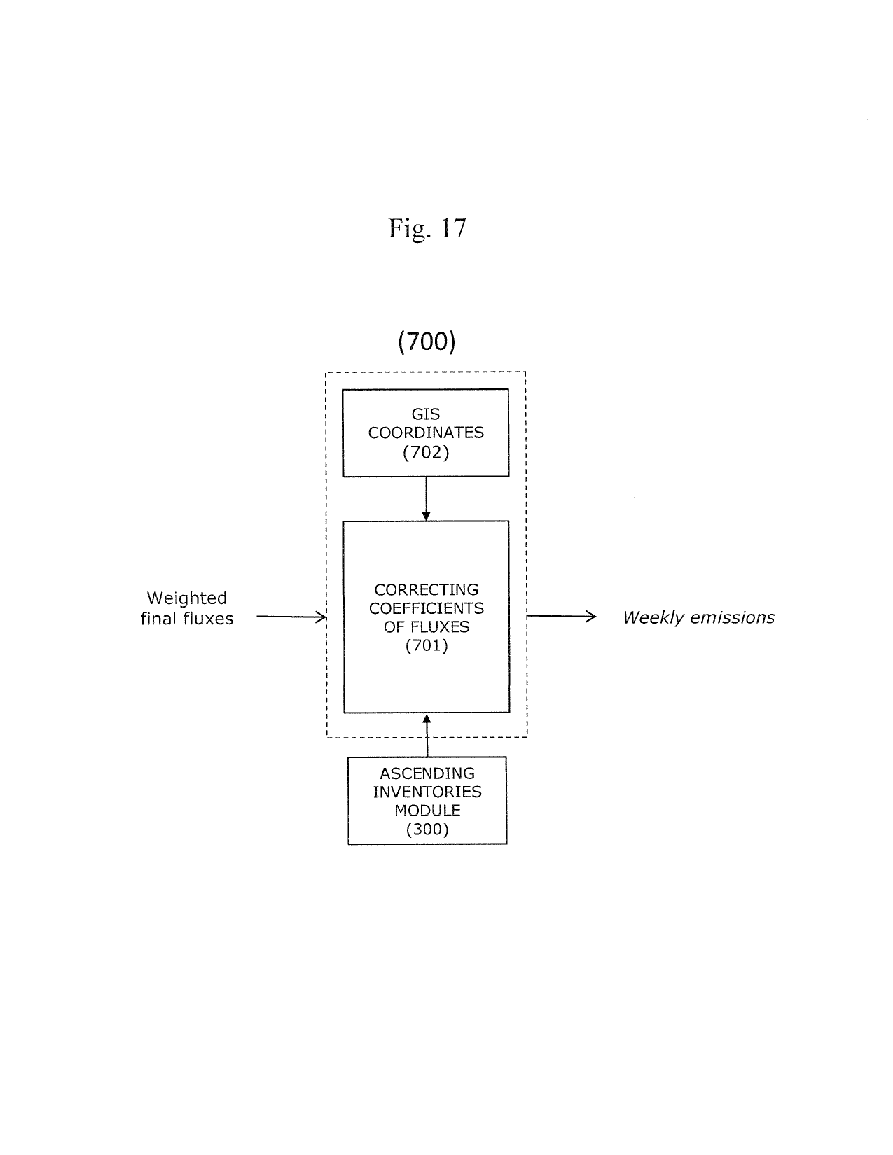

FIG. 17 presents a block diagram illustrating the geocoding module,

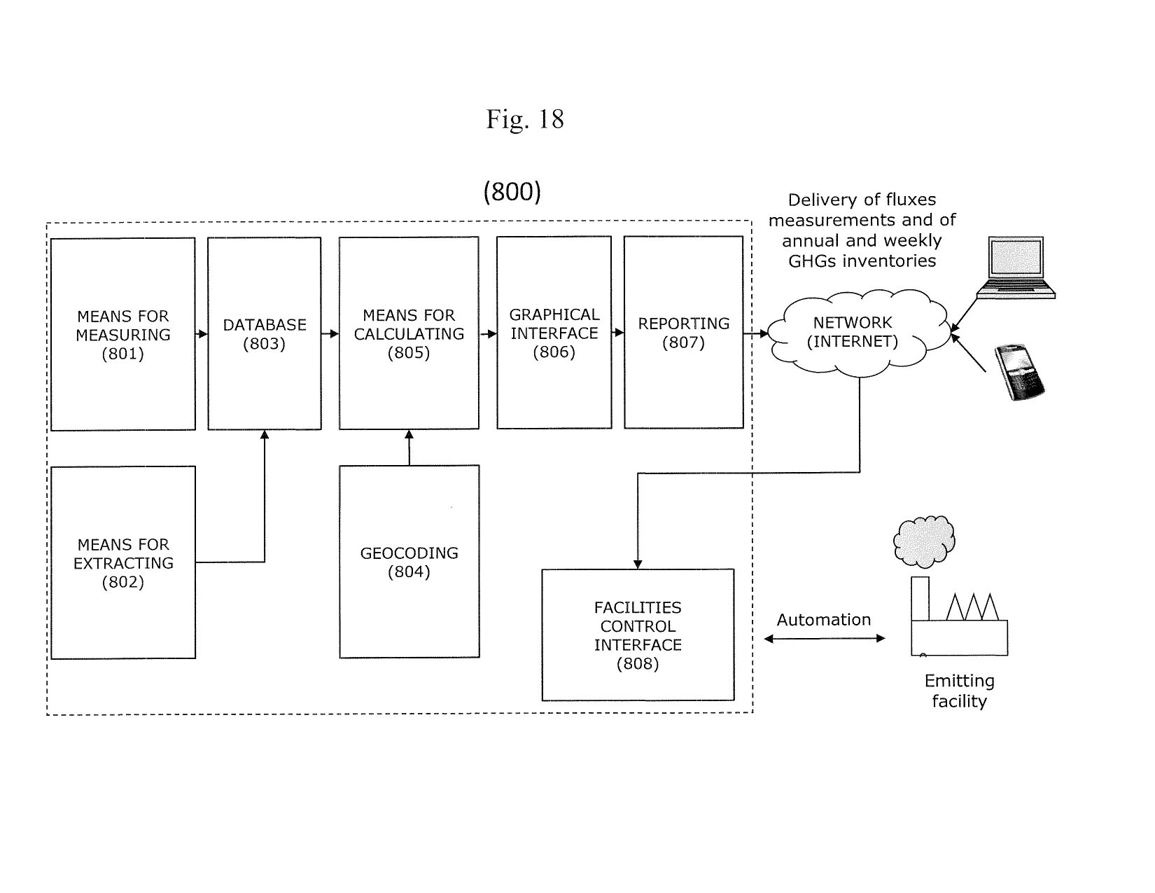

FIG. 18 presents a block diagram illustrating a measuring system according to the invention.

### DETAILED DESCRIPTION OF THE INVENTION

FIG. 1 presents, in a general manner, the different steps of the method for measuring according to the invention. The invention concerns a method for measuring and an accurate measuring system of GHGs inventories including CO2, CH4, N2O, NOx, HFC, HCFC, CFC, PFC, SF6, O3, H2O, CO and H2 from their natural and anthropogenic sources and sinks in a determined geographical area, in particular in an area of which the surface is between 1 km2 and 10,000 km2. The method is initially presented for CO2 and the same process is used for the other GHGs.

### I. CO2

For each of the greenhouse gases considered, and more particularly for CO2, the method for measuring according to the invention comprises in situ measurements of CO2 performed from a combination of observations (FIG. 1 Block 100) combining satellite measurements (FIG. 14 Block 101), aerial measurements (Block 102), atmospheric measurements (Block 103), marine measurements (Block 104) and ecosystem measurements (Block 105).

It also includes modeling of the CO2 fluxes on the globe, initialized at the beginning of the Holocene, using an exchange module (FIG. 1 Block 200). This exchange module uses a solar module (FIG. 9 Block 201), an energy module (Block 202), an ocean module (Block 203), a biosphere module (Block 204), a fire module (Block 205) and a fossil module (Block 206). An ascending inventories module enables one to obtain an accurate spatial distribution of gridded anthropogenic emission inventories (Block 301). The molar fractions are modeled for the entire atmosphere with a transport module (Block 400). The difference between the observations and model forecasts is minimized by the data inversion and assimilation module (Block 500) by adding a synthesis inversion with the Green function (Block 501), followed by the ensemble Kalman filter (Block 502) to obtain final fluxes as will be described in more detail below. The method for measuring according to the invention adds a validation and modulation of final fluxes by a weighting module (Block 600) to obtain final weighted fluxes, then finally uses a system of correcting coefficients to obtain, on the basis of the final weighted fluxes (Block 700), the calculated emissions at the facility scale in TCO2/year, TGHGs/year and TCO2 eq/year. An overview of the results of the different modules of the method follows:

| Blocks | Modules | Result | Grid |
|---|---|---|---|
| 100 | Observation module | Concentrations, | Local |
| | | fluxes and parameters | |
| 201 | Solar module | W/m2/day | 1° × 1° |
| 202 | Energy module | W/m2/day | 1° × 1° |
| 203 | Ocean module | PgC/month | 5° × 4° |
| 204 | Biosphere module | Kg/m2/s | 1° × 1° |
| 205 | Fire module | Kg/m2/month | 1° × 1° |
| 206 | Fossil module | T/year | Global |
| 300 | Ascending inventories | Kg/m2/week | 1° × 1° |
| | module | | |
| 401 | Transport module | ppm/s | 1° × 1° |
| 500 | Inversion and | Kg/m2/week | 1° × 1° |
| | assimilation module | | |
| 600 | Weighting module | T/week | Regions |
| | | | and |
| | | | countries |
| 700 | Geocoding module | GHGs in Kg/m2/week, | 0.1° × 0.1° |
| | | TCO2/year, | |
| | | TGHGs/year and | |
| | | TCO2eq/year | |

The method is first proposed for CO2, and then presents the other GHGs sources and sinks for which the same process is applied. It includes notably for CH4, the model used to model emissions from the permafrost and from the bottom of oceans from CH4 hydrates as will be described in more detail in point II.

### 1. Observation Module

In-situ continuous, high-precision and long term observations are necessary in order to understand the exchange processes of the carbon cycle and to reduce uncertainties of estimates. The method improves the Carbontracker by implementing a combination of satellite, aerial, atmospheric, ecosystem and marine measurements (Block 100, FIG. 14) in order to obtain a global observation of the planet with coverage of the different atmospheric layers and surfaces of the planet. This enables one to obtain a complete mapping in near real time of GHGs sources and sinks at world, continental, state, national, and local scales up to the facility level to reflect the reality of emission levels (FIG. 2). In addition, the joining of these five complementary and essential observation techniques enables one to process homogeneous concentrations and fluxes over the entire globe with detailed local visibility to obtain accurate inversion and assimilation results at the 1°×1° scale. All acquired measurements are saved in the observation module.

Satellite Observations

Satellite observations (Block 101, FIG. 14) preferably include a combination of the Japanese satellite GOSAT (Maksyutov et al. 2008) and the European satellite ENVISAT (Bovensmann et al. 1999) to obtain global measurement coverage of the different layers of the atmosphere, from the planetary scale to the facility level. These satellites measure the near infrared solar radiation reflected by the surface of the Earth and the atmosphere, which enables one to detect the GHGs atmospheric absorption in these spectral regions.

This requires great measurement sensitivity down to the surface where the sources and sinks signals are the strongest and the GOSAT satellite with its two instruments TANSO-FTS and TANSO-CAI currently in orbit (FIG. 4) provide this information with relative measurement accuracy on the order of 1% (4 ppm) and a footprint of 10 km in diameter (FIG. 5). The large local fossil sources such as emitting facilities increase the CO2 concentrations in the atmosphere from 1 to 10 ppm at the source and are generally scattered over a few tens of kilometers around it. The GOSAT satellite demonstrates its monitoring capacities by facility and samplings provide independent data to compare with the ascending inventories module (Block 300). With from 100 to 500 large local sources in countries of high emissions, it is possible to obtain a statistical measurement sample of CO2 plumes emitted by these major sources in these countries. The method uses a combination of the two algorithms Full Physics (FP) and Apparent Optical Path Difference (AOPD) (Boland et al. 2009) (Block 106) in order to recover the CO2 columns (XCO2) from radiations measured by GOSAT. With accuracy from 0.3% to 0.5% (1 to 2 ppm), a sample area less than 3 km2, the American satellite OCO (Crisp et al. 2004) has also been designed to measure concentration increases above the local sources and sinks. The method will complement the CO2 measurements with the successor of the OCO satellite when it becomes available, OCO having missed its launch in early 2009. The method also uses the SCIAMACHY spectrometer on ENVISAT currently in orbit and the combination of the two algorithms WFM-DOAS and BESD according to Buchwitz et al. (2008) (Block 106) in order to recover the CO2 columns (XCO2) from the radiation measurements. The development of these algorithms is advancing and has currently achieved 2-3% accuracy according to Schneising et al. (2008) with a horizontal resolution of 30 km×60 km (FIG. 5). The research goal is to achieve 1% relative accuracy, which is enough because a constant offset is taken into account in the data inversion and assimilation and a high level of relative accuracy is required to validate the models. GOSAT and SCIAMACHY data products are the column-averaged dry air mole fractions of CO2 (XCO2, ppm). For the measurement of other GHGs and the CO2 data validation, the GOSAT and ENVISAT (SCIAMACHY) satellites are complemented by AIRS, IASI, TES and OMI (FIG. 5).

The method for measuring according to the invention also uses the Atmospheric Infrared Sounder (AIRS) (Aumann et al., 2003) which is a multi spectral high resolution infrared sounder on the AQUA satellite designed to provide accurate data of the atmosphere, the surface and the oceans and provides measurements of the atmospheric temperature, humidity profiles, surface temperature and GHGs such as O3, CO, CO2, CH4 and H2O.

The method for measuring according to the invention also performs measurements through the Infrared Atmospheric Sounding Interferometer (IASI) (Crevoisier et al., 2009) which is a Fourier transform spectrometer on the METOP Satellite and provides infrared profiles measurements of temperature in the troposphere and the low stratosphere, humidity profiles in the troposphere and GHGs such as CO2, CH4, N2O, CO, H2O and O3.

The method for measuring according to the invention performs in addition measurements thanks to the Tropospheric Emission Spectrometer (TES) (Luo et al., 2007) which is a Fourier transform spectrometer on board of the EOS AURA providing a discrimination of radiatively-active molecular species in the bottom of the atmosphere. TES uses both natural thermal emissions from the surface and the atmosphere and the sunlight reflected providing a day-night coverage on the globe with measurements of CO2, CO, CH4, O3, H2O and NO2.

In addition, the method for measuring according to the invention performs measurements by means of the Ozone Monitoring Instrument (OMI) (Levelt et al. 2000) which is a spectrometer on board the EOS AURA measuring the spectrum of ultraviolet/visible/near infrared wavelengths with a high spectral resolution. OMI provides in particular the total columns of tropospheric and stratospheric measurements of O3, H2O and NO2 as well as the O3 stratospheric profiles, the surface albedo, aerosols and cloud cover parameters.

The method also uses preferably data from the MODIS instrument of the Terra and Aqua satellites which provides objective data of land cover change (ALCC, Anthropogenic Land Cover Change).

GHGs satellite data are preferably validated by the Fourier transform spectrometers networks on the ground, Network for the Detection of Atmospheric Composition Change (NDACC) (Kurylo, 1991) and Total Carbon Column Observing Network (TCCON) (Toon, 2009). These stations log the direct solar spectra in the near-infrared spectral region with for NDACC, the measurement of O3, CO, CO2, N2O, CH4 and for TCCON, that of CO2, CH4, N2O, CO and H2O.

Measured parameters and their frequency when they are available include:

| Measurements | Frequency |
|---|---|
| GHGs (including CO2, CH4, CO, N2O, NOx, H2O, O3) | Continuous |
| ALCC | Continuous |
| Albedo | Continuous |

Aerial Observations

The method for measuring according to the invention complements the satellite measurements with measurements performed thanks to aerial observations, measurements which are also logged in the observation module. Satellite observations are complemented by the available aerial observations performed by the NOAA ESRL Carbon Cycle Greenhouse Gases group (CCGG) Air sampling, as well as by the measurements of the In-service Aircraft for a Global Observing System—European Research infrastructure (IAGOS-ERI) program. The NOAA ESRL Air sampling enables one to perform vertical profile measurements of CO2, CH4, N2O, CO, H2 and SF6. IAGOS-ERI originates from the MOZAIC program (Marenco et al. 1998) and includes the CARIBIC program (Schuck et al. 2009) and provides GHGs in-situ high-quality observations in the tropopause including CO2, CH4, CO, N2O, H2O, O3, CFC, HFC and HCFC.

| Measurements | Frequency |
|---|---|
| GHGs (including CO2, CH4, CO, N2O, H20, | Continuous and |
| O3, CFC, HFC, HCFC, SF6, H2) | weekly sampling |

Atmospheric Observations

The method for measuring according to the invention also performs atmospheric concentration and sample measurements taken from the NOAA ESRL Cooperative Global Air Sampling Network and the CSIRO Air Sampling Network sites for each year. It also uses in situ quasi continuous time series of NOAA ESRL towers and observatories. These observations are calibrated on the worldwide standard (WMO-2005). The method complements these atmospheric observations (Block 103, FIG. 14) by preferably including the current ones and those in development of the Global Atmosphere Watch (GAW) including the WDCGG stations, the International Global Atmospheric Chemistry Observations (IGACO), the GCOS Reference Upper-Air Network (GRUAN), the Network for the Detection of Atmospheric Composition Change (NDACC) including LIDAR stations, the Integrated Carbon Observation System (ICOS), the System for Observation of Halogenated Greenhouse Gases in Europe (SOGE) and the ALE/GAGE/AGAGE network (FIG. 6).

Each station is an observatory which continuously measures the regional and world variability of concentrations of CO2 (ppm), of GHGs as well as the meteorological parameters. They are used to detect the long term changes in concentration trends and the inter-annual variability associated with anthropogenic emissions and climate anomalies. Some stations are also equipped with flux measurement instruments. Each station is generally representative of a footprint area of more than 100 km. The CO2 concentration measurements are ideally performed with an accuracy less than 1 ppm and air samples are also collected, preferably on a weekly basis and then analyzed. Measured parameters and their frequency when they are available include:

| Measurements | Frequency |
|---|---|
| CO2 | Continuous (30 min) |
| Meteorological parameters (pressure, | Continuous (30 min) |
| temperature, relative humidity, wind) | |
| Boundary layer height | Continuous (30 min) |
| CO2 fluxes | Continuous (30 min) |
| GHGs (including CH4, CO, N2O, NOx, H20, | Continuous and |
| O3, CFC, HFC, HCFC, SF6, H2, PFC) | weekly sampling |

Marine Observations

The method for measuring according to the invention also performs measurements via marine observations (Block 104, FIG. 14) performed by means of a network of instrument-equipped ships sailing the oceans and at fixed stations (FIG. 7). The ships are in general commercial ships, ferries, container ships and tankers operating on regular routes. The fixed stations are sites on the ocean for which continuous temporal observations are logged through moorings and research vessels. The coverage must be sufficient to include all the oceanic air-sea fluxes of oceanic regions (Pacific, Atlantic, Indian, Southern, Arctic). The method includes the observations of the programs International Ocean Carbon Coordination Project (IOCCP), IOCCP underway lines, JCOMM VOS, IOCCP time series (Oceansites), IOCCP Hydrography (GO-SHIP), CarbonOcean-IP, SOLAS-IMBER Carbon Group (SIC), Carbon Dioxide Information Analysis Center Ocean CO2 Center (CDIAC), National Oceanic & Atmospheric Administration (NOAA) VOS, Climate Variability and Predictability Research (CLIVAR) and Integrated Carbon Observing System (ICOS).

The ships and fixed stations are equipped with automated instruments that measure the atmospheric concentration and the partial pressure of CO2 from the surface, surface temperature and salinity. Some ships and marine stations are equipped with instruments for measuring atmospheric concentration of additional GHGs repeated at daily and monthly intervals, and air samples are regularly collected and then analyzed. The air-sea fluxes are calculated from measurements of CO2 partial pressure, as performed in the Carbontracker using the inversion principle of Jacobson et al. (2007) (Block 107). Measured parameters and their frequency when they are available include:

| Measurements | Frequency |
|---|---|
| atmospheric CO2 | continuous (30 min) |
| Ocean pCO2, total atmospheric pressure | continuous (30 min) |
| Ocean surface temperature and salinity | continuous (30 min) |
| Meteorological parameters | 4-hours |
| GHGs (including CO2, CH4, CO, N2O, H2O, HFC, | Continuous and |
| SF6, H2) | monthly sampling |

Ecosystem Observations

The method also performs measurements via ecosystem observations (Block 105, FIG. 14) of the Fluxnet/iLEAPS program (Baldocchi et al. 2001) which is a network of regional networks and preferably includes the current and in-development ecosystem stations of Carboeurope-IP, CarboAfrica, Asiaflux, Afriflux, Ozflux, Large-Scale Biosphere-Atmosphere (LEA), US-China Carbon Consortium (USCCC), Nordic Center for Studies of Ecosystem Carbon Exchange and its Interactions with the Climate System (NECC), TCOS-Siberia, ChinaFlux, Ameriflux, Fluxnet-Canada, KoFlux as well as the Integrated Carbon Observation System (ICOS) (FIG. 8).

Each station continuously measures the CO2 fluxes, the water and energy fluxes between terrestrial ecosystems and the atmosphere as well as the ecosystem variables such as the meteorological variables, hydrological and radiation budgets and the carbon pools in the vegetation and soil. The stations transfer the collected data of ecosystem fluxes, preferably daily. Some stations are also equipped with concentration measurement instruments of atmospheric stations. The data are used to define and validate the carbon models applied on continental scales, to detect the long-term changes in sinks and sources and identify the impact of differences in management of the carbon budget. The footprint of each tower is on average between 200 and 1000 meters. Fluxes (Kg/m2/s) are measured using the covariance method of turbulences (Eddy covariance) from direct measurements of vertical wind speed and CO2 concentrations to determine the vertical turbulent fluxes within the atmospheric boundary layers (Block 108). Air samples for GHGs measurement are regularly collected and then analyzed. Measured parameters and their frequency when they are available include:

| Measurements | Frequency |
|---|---|
| Sensible heat fluxes, CO2, H2O | Continuous (30 min) |
| CO2 vertical profile | Continuous (30 min) |
| Global net reflected and diffused radiation | Continuous (30 min) |
| Air and soil temperature profiles | Continuous (30 min) |
| Wind speed profile | Continuous (30 min) |
| Soil water content profile | Continuous (30 min) |
| Precipitation, snowfall and ground height | Continuous (30 min) |
| Soil heat fluxes | Continuous (30 min) |
| Soil carbon content | Sampling over 5 years |
| Biomass | Annual |
| Management and disturbances | Annual |
| CH4 fluxes | Continuous (30 min)/Daily |
| N2O fluxes | Continuous (30 min)/Daily |
| Canopy temperature | Continuous (30 min) |
| Spectral reflectance | Continuous (30 min) |
| Below canopy Photosynthetic | Continuous (30 min) |
| Active Radiation | |
| Groundwater level | Continuous (30 min) |
| Sap flow | Continuous (30 min/3 hours) |
| Soil respiration | Continuous (3 hours) |
| Phenology camera | Daily |
| N deposition | Biweekly |
| Leaves and soil N content | Biweekly |
| Litter fall | Monthly |
| C and N import and export due | Annual |
| to biosphere management | |
| GHGs (including CO2, CH4, CO, O3, | Continuous and |
| N2O, NOx, H2O, SF6, | weekly sampling |
| H2, HFC, HCFC, PFC) | |

### 2. Exchange Module

Along with the taking of measurements, the method according to the invention performs a modeling of the GHGs fluxes evolution, including CO2, from the Holocene, using an exchange module (FIG. 9). The exchange module comprises a solar module, an energy module, an ocean module, a biosphere module, a fire module and a fossil module.

a. Solar Module

The method for measuring according to the invention improves the calculation of solar radiation of the Carbontracker, using a solar module (Block 201, FIG. 9) which models solar radiation with a more precise influence on the exchanges between the atmosphere, oceans and biosphere.

The solar insolation is the amount of solar radiation reaching the Earth by latitude and by season and refers to the radiation arriving at the top of the atmosphere (TOA, Top of Atmosphere). According to the orbital theory of paleoclimates, variations in the Earth's orbit through time have contributed to change the amount of solar radiation received by the Earth in each season and have driven the alternations of glacial and interglacial periods. According to the Milankovitch cycles, three parameters of the Earth's orbital geometry are used to evaluate the orbital forcing: obliquity, which is the tilt of the ecliptic compared to the celestial equator with a cycle of about 40 thousand years (Ka), eccentricity of the Earth's orbit around the sun with a cycle of about 100 Ka and climatic precession, which is related to the Earth/Sun distance at the summer solstice with a cycle of about 26 Ka. According to this theory, the interglacial periods tend to happen during periods of more intense summer solar radiation in the northern hemisphere and since about 11,700 years, the Earth has entered into a new interglacial cycle called the Holocene.

As a new approach, the method for measuring according to the invention thus begins the CO2 exchange modeling at t=0 from the beginning of the Holocene in order to obtain a stable and calibrated basis of natural exchanges to determine with more precision the future influence of anthropogenic emissions from the industrial era. For the calculation of solar insolation, the orbital parameters of the terrestrial geometry are obtained by using the theory of the Secular Variations of the Planetary Orbits of Bretagnon (1987).

The inventor of the method also adds a modification in the calculation of eccentricity, because to his knowledge, no precise influence of the Moon on the solid and oceanic tidal dissipation of the Earth has been taken into account to calculate the disturbance on Earth eccentricity and the incident solar insolation. Phobos, one of the satellites of Mars is used to assess this influence as it is the best known case of rapid orbital evolution of a satellite in the solar system with an orbital period of only 7.65 hours, compared to 27.3 days for the Moon. Its orbital motion has been intensively studied since its discovery in 1877 where it has completed approximately 145,500 orbits, equivalent to a period of 10,880 years for the Moon. The instrument Mars Orbiter Laser Altimeter (MOLA) on the satellite Mars Global Surveyor has observed transits of the shadow of Phobos on the surface of Mars, and has directly measured the distance with Phobos to verify if the observed positions of Phobos and its shadow are in good agreement with the models. Given the long period of time and the accuracy of observations, Phobos secular acceleration is used to determine the quality factor (Q) of Mars, which expresses the relative rate of energy dissipation and which is associated with the number of Love (k2), describing the elastic properties of the planets. The accurate measurement of these parameters enables one to determine the energy dissipation effect on Mars eccentricity. With its strong proximity to Mars, the orbit of Phobos experiences a secular orbital acceleration which is used to evaluate that of the Moon with the Earth. On Earth, the Moon exerts a gravitational pull causing ocean and solid tides. The Earth induces a secular acceleration, which has a cumulative effect on the Moon's position when extrapolated over centuries. The effect of the secular acceleration of the Moon is quite poorly known because recordings of its deviations go back about a century. A precise measurement of Mars eccentricity thus enables one to infer the disturbance of the Moon on Earth's eccentricity. The method evaluates this factor as a proportion of the Phobos-Mars distance, the Moon-Earth distance and the respective eccentricities:

$$\frac{{e}_{Earth}}{{D}_{Moon \text{-} Earth}} \approx \frac{{e}_{Mars}}{{D}_{Phobos \text{-} Mars}}$$

The instantaneous insolation is defined as the energy received per unit time and surface area on a horizontal plane at TOA and the method follows the approach of Liou (2002) for its calculation. The trajectory of the earth around the Sun is an ellipse (FIG. 10). The closest point of the earth's orbit to the Sun is called the Perihelion, while the Aphelion is the farthest. The ellipse shape is characterized by its eccentricity e=\sqrt{(a²−b²)}/a. The distance (r) from the Earth to the Sun is calculated as a function of ν, the true anomaly of the ellipse according to the first law of Kepler.

$$r = \frac{a ( 1 - {e}^{2} )}{1 + e cos v} .$$

The amount of incoming solar radiation per unit surface area at TOA is a function of r and the average Sun-Earth distance (rₒ) is defined according to the second law of Kepler:

rₒ²=a²\sqrt{(1−e²)}≈a²

On average, the amount of incoming solar energy outside the Earth's atmosphere is the multiplication of the solar constant Sₒ by the surface which intercepts the Sun rays. Sᵣ is the amount of solar radiation per unit area measured on the outer surface of the atmosphere in a plane perpendicular to the rays at a distance (r) from the Sun and is a function of Sₒ. At TOA, a surface at the mean Earth-Sun distance perpendicular to the rays receives Sᵣ=S₀ rₒ²/r². The amount of solar energy received per unit time on a unit horizontal surface at TOA is a function of θo, the solar zenith angle (FIG. 11). Sₕ is inferred as a function of solar ray orientation and of a normal to the Earth surface according to:

$${S}_{h} = {S}_{r} cos {θ}_{o} = {S}_{0} \frac{{r}_{o}^{2}}{{r}^{2}} cos {θ}_{o}$$

The Earth's rotational axis is not perpendicular to its orbital plane and is tilted relative to the celestial equatorial plan by the angle ε. The vernal equinox is used as a reference to define the real longitude λ with ω, the longitude of the perihelion measured from the autumnal equinox (FIG. 11). From spherical trigonometry, the solar zenith angle depends on the latitude φ, from a point on Earth, the solar declination δ and the hour angle h, according to:

cos θₒ=sin φ sin δ+cos φ cos δ cos h

where h indicates the time since which the sun was at the local meridian, measured from the observer's meridian westward. δ is defined as the angle between a line from the center of the Earth towards the Sun and the celestial equator. H represents a half-day and is defined by cos H=−tan φ tan δ. Knowing the true longitude and the obliquity, δ varies throughout the seasons according to sin δ=sin ε·sin λ and the solar energy received per unit area per day is calculated according to:

$${S}_{h , day} \approx \frac{{S}_{0}}{π} {( \frac{{r}_{o}}{r} )}^{2} ( H sin φ sin δ + cos φcos δ sin H )$$

During the Holocene, this solar energy is mainly influenced by the precession, and then by the obliquity. From this calculation, the precession was at its highest point at the beginning of the Holocene contributing predominantly at this stage to the highest insolation and decreased up to its minimum around 1300 AD. Since then, the precession increases up to a maximum around approximately 10 Ka AD finishing its cycle. This insolation therefore increases since 1300 AD and has a significant influence on the CO2 fluxes of the oceans and the biosphere. This modeling of the solar radiation in W/m2/day on 1°×1° grids is used in the energy module (Block 202). The calculation of the solar radiation TOA is initialized at the beginning of the Holocene with a periodicity of 50 years and a global calculation for the planet.

b. Energy Module

The method for measuring according to the invention also improves the Carbontracker by using an energy module (Block 202, FIG. 9) which models the shortwave and longwave radiations with a more accurate influence on the exchanges between the atmosphere, oceans and biosphere. It includes notably a more accurate calculation of the solar radiation absorption by the GHGs, of the influence of the ozone layer hole and of the greenhouse effect.

The calculation of the incident shortwave radiation is performed according to the method of Huybers et al. (2007). This radiation, mainly of solar origin, is the result of multiple scattering and absorption processes involving essentially H20, O3 molecules, aerosols, clouds, the air and the underlying surface (FIG. 12). This is modeled using the solar insolation of the solar module (Block 201), reflectivity (R), absorptivity (A), transmissivity (T) of the atmosphere and clouds and the albedo (α). When there is energy equilibrium, A+R+T=1 with A, R and T, parameters evolving as a function of the climate. The denominator takes into account the absorption and the reflection of radiation by the surface multiple times according to:

$${S}_{s} ↓ = {S}_{h , day} \cdot \frac{T ( 1 - α )}{α \cdot R}$$

The albedo is determined from the Carbontracker for the oceans and the atmosphere, from the new biosphere module for the terrestrial surface and is validated by the satellite observations. Its calculation is important because it varies mainly as a function of cloudiness, snow, ice, the leaf surface area and of land cover changes.

The method for measuring according to the invention also improves the calculation of the shortwave radiation by adding the influence of the ozone layer hole because ozone is an excellent absorber of UV rays. In 1970, it was discovered that the ozone is destroyed by radicals including hydrogen, nitrogen, chlorine and bromine. With the depletion of the ozone layer, the protective filter provided by the atmosphere is progressively reduced. During the winter solstice period, the ozone layer hole is primarily located above the Antarctic and the insolation increase on this pole has strongly contributed to the increase in shortwave radiation exacerbating global warming. Ozone is a key indicator integrated in the method to measure this increase and is calculated with its transmissivity T_{O3} according Tripathi et al. (2000)

T_{O3}=e^{-αμΩ}

where α is the ozone absorption coefficient, μ is the ratio of the actual and vertical path lengths through the ozone layer and Ω is the concentration of ozone.

To achieve climate equilibrium, the incoming solar energy absorbed by the earth/atmosphere system is balanced by an equal amount of emitted thermal IR energy (FIG. 12). The Earth has an atmosphere, which absorbs and emits longwave radiation and this greenhouse effect serves to keep the heat close to the surface. The absorption is dependent on the wavelength and is determined by the atmospheric composition, clouds, aerosols and the GHGs concentrations. The processing of longwave radiation is based on the Schwartzschild equation according to Washington et al. (2005) and takes into account the absorption and emission with the laws of Lambert and Kirchhoff's with the change of radiation intensity expressed according to:

dl=−lkρdz+B(T)kρdz

where k is the absorption coefficient, ρ is the density of the medium and B(T) is the Planck function. The integration over all angles of the hemisphere above a horizontal surface transforms the intensities in upward and downward fluxes. The simplification of the model is performed by using the emissivity method in which integration over relatively broad spectral intervals results in the calculation of upward Fₛ ↑ and downward Fₛ ↓ fluxes with the emissivities ε′ and ε which are functions of the water vapor, pressure and temperature for the path through which the radiation passes. The influence of GHGs such as O3, CH4, NO2 and CO2 is also modeled in the absorption (A).

Fₛ↑(z)=πB(0)+∫₀^{z}ε′(z,z′)d(πB(z′));Fₛ↓(z)=πB(zₒ)ε(z,∞)+f_{zo}^{z}ε′(z,z′)d(πB(z′))

$${ɛ}^{′} ( z , {z}^{′} ) = {\sum }_{i} {A}_{i} ( z , {z}^{′} ) \frac{d {B}_{i} ( {z}^{′} )}{d B ( {z}^{′} )} ; ɛ ( z , {z}^{′} ) = {\sum }_{i} {A}_{i} ( z , {z}^{′} ) \frac{{B}_{i} ( {z}^{′} )}{B ( {z}^{′} )}$$

The ground, surface and atmosphere exchange heat through direct contact between the surface and the air (sensible heat Hₛ↑), through evaporation and transpiration (latent heat LᵥE↑) calculated according to the method used by Xing et al. (2007) and through absorption into the ground (conduction Gₛ↓) according to the general law of Fick. Without transfer of latent and sensible heat, the Earth's surface would have a temperature much higher. When evaporation takes place at the surface, the latent heat required for phase transition is taken out of the surface resulting in cooling. During the formation of clouds, water vapor condenses and the latent heat is released into the atmosphere. This leads to a net heat transfer from the surface to the atmosphere, one of the main drivers of the atmospheric circulation. The ratio of sensible and latent heats is called the Bowen ratio (Bₒ=Hₛ/LvE). The conduction flux happens on solid surfaces such as the ground and the ice and for the ocean, it is related to the dynamics of mixing of the ocean layers.

$${H}_{s} ↑ = {ρ}_{a} {c}_{p} {c}_{h} \frac{\partial T}{\partial z} ; LvE ↑ = \frac{ɛ ρ}{P} {L}_{v} {c}_{l} \frac{\partial e}{\partial z} ; {G}_{s} ↓ = χ \frac{\partial T}{\partial z}$$

where cₚ is the specific heat capacity of the air, ρₐ the density of the air, cₕ the turbulent heat transfer coefficient, T the temperature, z the height, Lᵥ the latent heat of vaporization, e the vapor pressure of the air, ε the ratio of the moist and dry air molecular weights, cₗ the water vapor transfer coefficient and χ the thermal conductivity of the medium.

The inclusion of the shortwave and longwave flux components with Cₛ the thermal capacity of the surface layer enables one to calculate the radiative budget at the surface of the globe.

$${C}_{s} \frac{\partial {T}_{s}}{\partial t} = {S}_{s} ↓ + {F}_{s} ↓ - {F}_{s} ↑ - {H}_{s} ↑ - {L}_{v} E ↑ - {G}_{s} ↓$$

At thermodynamic equilibrium cₛ∂Tₛ/∂t=0, which enables one to calculate the surface temperature Tₛ to determine its influence on the oceans and the biosphere. The budget and its components are calculated in W/m2/day on 1°×1° grids and are used in the ocean and the biosphere modules. The meteorological modeling of the atmospheric transport module (clouds, GHGs) are integrated into the energy module for the data update. In-situ parameters measurement of fluxes of heat, of radiation, and of GHGs during observations (Block 100) enables one to validate the data of the module with real measurements. The energy budget calculation is initialized at the beginning of the Holocene with a periodicity of 50 years and a global calculation on the planet.

c. Ocean Module

In order to obtain a more accurate oceanic absorption, the method for measuring according to the invention improves the current Carbontracker module by using an ocean module including the addition of CO2 release by evaporation, the absorption by chemical weathering and the buffer effect (Block 203, FIG. 9).

Oceans are the largest long-term carbon sinks due to their strong storage and redistribution capacity within the system. The method for measuring according to the invention models the absorption primarily by the dissolution of atmospheric CO2 between the air and the oceans with the difference in CO2 partial pressure (pCO2), wind speed and water temperature, thus modifying its carbonate balance towards a more acidic state. It also models the release according to local temperatures, biological activity, wind speed and ocean circulation. The CO2 exchanges are calculated from mass transfer:

F_{oce}(t)=F_{oce}(t)↑−F_{oce}(t)↓

A CO2 increase in the atmosphere causes an increase in partial pressure, which increases the rate at which it is dissolved in water. The CO2 partial pressure follows Henry's law, where Kₒ is the solubility coefficient of CO2 in water.

[CO2]_{seawater}≦K_{o(S,T)}·p_{CO2}(t)

According to Fick's law, the ocean absorption J is determined by calculating the diffusion flux of CO2, generally described as the product of the gas transfer velocity k_{w} with the gradient of CO2 concentration between water and marine air. It is also a function of the ocean depth zₘ which takes into account shallow waters particularly near the coast.

$$J = \frac{{k}_{w}}{{z}_{m}} ( {[ CO 2 ]}_{saturated} - {[ CO 2 ]}_{seawater} )$$

The spatial and temporal variability of CO2 air-sea exchange thus depends on the wind speed distribution, temperature, the dissolved CO2 concentration, and the solubility Kₒ. This absorption is calculated in the method by using the difference in CO2 partial pressure between the air and the ocean combined with a gas transfer velocity. The pCO2 levels are determined using different configurations of the Princeton/GFDL MOM3 model, then by dividing with a gas transfer velocity calculated from the weather model forecasts ECMWF (European Center for Medium-range Weather Forecast), ERA40, integrated into the transport module (Block 400). The gas transfer velocity is defined as a quadratic function of the wind speed, using the formulation for instantaneous winds. The air-sea transfer is inhibited by the presence of ice and fluxes are scaled in each grid by the daily fraction of ice provided by the ECMWF data forecasts.

An increase in CO2 concentration in the atmosphere leads to an increase in the quantity of CO2 absorbed by the oceans, which gradually decreases. The method adds this buffer capacity reduction of the system by the method of Wolf-Gladrow (1994). The sum of dissolved carbonate species is defined as the total of dissolved inorganic carbon [DIC]. The CO2 in the ocean forms a weak carbonic acid, H2CO3 which dissociates under the dominant form of inorganic carbon storage, the bicarbonate ion HCO3⁻ and then in the carbonate ion CO3²⁻ with K₁═[HCO3⁻][H⁺]/[CO2_{(aq)}] and K₂═[CO3²⁻][H⁺]/[HCO3⁻], the dissociation constants according to:

$$CO {2}_{( aq )} + H {20}_{( l )} -> H 2 CO {3}_{( aq )} \begin{matrix}K 1 \\ ⇄\end{matrix} {H}^{+} + HCO {3}^{-} \begin{matrix}K 2 \\ ⇄\end{matrix} 2 {H}^{+} + CO {3}^{2 -}$$

The CO2 concentration in the ocean is dependent on the solubility and the CO2 partial pressure in the atmosphere and the total [DIC] in solution is inferred from the dissociation constants and the concentration of hydrogen ions.

$$[ DIC ] = \sum CO 2 = [ CO 2 ] + [ HCO {3}^{-} ] + [ CO {3}^{2 -} ] \approx {p}_{CO 2} ( t ) \cdot {K}_{o ( S , T )} ( 1 + \frac{{K}_{1}}{[ {H}^{+} ]} + \frac{{K}_{1} \cdot {K}_{2}}{{[ {H}^{+} ]}^{2}} )$$

The fraction of the CO2 flux from the atmosphere to the mixed layer that will react is a function of the buffer factor ζ, which is the fractional change of atmospheric CO2 divided by the fractional change of [DIC] after equilibrium has been established. ζ depends on temperature, [DIC], salinity and alkalinity (Alk≈[HCO3⁻]+2[CO3²⁻]+[OH⁻]+[B(OH)⁴⁻]−[H⁺]).

$$ζ = {( \frac{\partial [ CO 2 ]}{[ CO 2 ]} )}_{at m} / {( \frac{\partial [ DIC ]}{[ DIC ]} )}_{seawater}$$

According to the method of Trenbeth (1992), the flux is corrected using the following equation:

$$J = ζ \frac{{[ CO 2 ]}_{seawater}}{[ DIC ]} \cdot \frac{{k}_{w}}{{z}_{m}} \cdot ( {[ CO 2 ]}_{saturated} - {[ CO 2 ]}_{seawater} )$$

The method also adds an induced absorption by chemical weathering of CO2 where the alteration of rocks on the continental surface consumes atmospheric CO2 to produce alkalinity. Alkalinity is then transported by rivers and streams and precipitated in calcium carbonate in the oceans, which are deposited by sedimentation. This weathering is integrated following the global model CDIAC DB1012 of 1°×1° resolution of Suchet et al. (1995) which contains estimates of the net surface/atmosphere flux of CO2 (moles/km2/year) as well as bicarbonate transport (HCO3⁻) from rivers to the ocean. The model is based on a set of empirical relationships between CO2 flux (F_{CO2weathering}) and the runoff on the main types of rocks that surface on the continents. The oceanic absorption is modeled according to:

$${F}_{oce} ( t ) ↓ \approx ζ \frac{{[ CO 2 ]}_{seawater}}{[ DIC ]} \cdot \frac{{k}_{w}}{{z}_{m}} \cdot ( {[ CO 2 ]}_{saturated} - {[ CO 2 ]}_{seawater} ) + {F}_{CO 2 weathering} .$$

The method also complements the ocean module with the evaporation of CO2. Combined with the insoluble calcium carbonate, the CO2 dissolution reaction produces a calcium bicarbonate solution Ca(HCO3)2, which accumulates in the oceans.

H2CO3_{(weak acid)}+CaCO3₍ₗᵢₘₑₛₜₒₙₑ₎→Ca(HCO3)₂₍ₛₒₗᵤₜᵢₒₙ₎

On the ocean surface, wind and tide cause waves and choppiness, accompanied by fine spray and foam. The incident solar radiation directly creates an IR radiation through latent heat, which causes a rise in ocean temperatures and evaporation of these sprays and foam. The water vapor is also decomposed into precipitation and latent heat release.

Latent heat+Ca(HCO3)2₍ₛₒₗᵤₜᵢₒₙ₎→CaCO3₍ₗᵢₘₑₛₜₒₙₑ₎+CO2_{(gas)}+H20₍ᵥₐₚₒᵣ₎

H20₍ᵥₐₚₒᵣ₎→H20_{(liquid)}+Latent heat

In the ocean, the dominant form of inorganic carbon storage is the bicarbonate ion. In a solution of Ca(HCO3)2, two HCO3⁻ molecules store one CO2 molecule and the amount K_{c} of CO2 stored which can be potentially released by evaporation is Kc=[HCO3⁻]/2.M_{CO2}. The CO2 concentration stored in Ca(HCO3)2 and releasable by evaporation is also higher than the concentration of CO2 in solution. It is considered that the average evaporation rate over water is more important than on land having less exposed water. The satellite IR spectral observations also indicate that almost all of the IR radiations emitted by the oceans come from the water vapor above the surface (latent heat). At radiation balance, it is assumed that almost 100% of the solar radiation absorbed by the oceans causes water evaporation. With a covered fraction of approximately 70.8%, the fraction of solar energy that evaporates water from the oceans is considered equivalent to Fₚ·≈0.7. The latent heat is determined from the equation of the energy module (Block 202) according to:

LᵥE↑=Fₚ(Sₛ↓+Fₛ↓−Fₛ↑−Hₛ↑−Gₛ↓)

It is also assumed that almost all the evaporation from the surface of the ocean is due to that of sprays or foam from waves, leading to Fₛ≈1. In order to assess the release of CO2 with the evaporation rate E at constant water temperature, E is proportional to the radiation and to Lᵥ, the latent heat of vaporization. The method evaluates the release by evaporation according to the following proportion:

$${F}_{eva} ( t ) ↑ \approx E \cdot Kc \cdot Fs \approx ( {S}_{s} ↓ + {I}_{s} ↓ - {I}_{s} ↓ - {I}_{s} ↑ - {H}_{s} ↑ - {G}_{s} ↓ ) \cdot \frac{Fp}{Lv} \cdot Kc \cdot Fs$$

Absorption of the oceans is thus mainly driven by the increase in CO2 atmospheric concentration, their buffer capacity, chemical weathering and evaporation which is influenced by the solar insolation.

$${F}_{oce} ( t ) \approx ( {S}_{s} ↓ + {I}_{s} ↓ - {I}_{s} ↑ - {H}_{s} ↑ - {G}_{s} ↓ ) \cdot \frac{Fp}{Lv} \cdot Kc \cdot Fs - ( \begin{matrix}ζ \frac{{[ CO 2 ]}_{seawater}}{[ DIC ]} \cdot \frac{{k}_{w}}{{z}_{m}} \cdot \\ ( {[ CO 2 ]}_{saturated} - {[ CO 2 ]}_{seawater} ) + \\ {F}_{CO 2 weathering}\end{matrix} )$$

The result of the ocean module is a mapping of oceanic exchanges 5°×4° in PgC/month. The measurement of in-situ oceanic parameters from marine observations (Block 104) (ocean pCO2, atmospheric pressure, salinity, temperature) enables one to validate the data of the module with real measurements. The calculation of the ocean flux is initialized at the beginning of the Holocene with a periodicity of 50 years and a global calculation on the planet.

d. Biosphere Module

The air/biosphere exchanges are processed by the biosphere model JSBACH from Raddatz et al. (2007) (Block 204, FIG. 9) instead of the CASA model used by the Carbontracker. JSBACH has notably the advantage of processing anthropogenic land cover changes on Earth's surface. The absorption of CO2 is governed by photosynthesis and the release by respiration and disturbances. CO2 exchanges are modeled using mass transfer.

Plants absorb CO2 during photosynthesis by diffusion through the stomata which are the pores of leaves and stems by which CO2 is taken and converted under the influence of active visible radiation into carbohydrates.

$$6 CO 2 + 12 H 2 O {}^{sunlight} C 6 H 12 O 6 + 6 O 2 + 6 H 2 O$$

Biotic factors affecting photosynthesis include growth form, leaf type, photosynthetic pathway (C3, C4) and longevity. C3 is the photosynthesis of most of the plants while C4 is an adaptation to arid conditions with better water use. The vegetation types are modeled using different Plant Functional Types (PFT) and a representation of the different biomes (forests, shrubs, peatlands, grasslands C3 and C4, swamps, tundra, cultivated lands, glaciers . . . ). Photosynthesis is modeled by the equations describing the CO2 emission fluxes and water vapor at the leaf level and scaled to the canopy. The leaf area index is calculated as a ratio of total upper leaf surface of the vegetation divided by the surface area on which it grows.

$$Λ = \frac{total leaf area}{ground area}$$

The leaf area is calculated interactively with the climate and seasons of growth and decay are modeled according to:

$$\frac{d Λ}{d t} = k ( 1 - \frac{Λ}{{Λ}_{ma x}} ) Λ - p Λ$$

where k is the growth rate with k=0 for NPP≦0 and k≧0 when NPP≧0 and pΛ is the shedding rate (loss of leaves). Light influences the photosynthesis of the canopy and varies as a function of its architecture during its passage. The fraction of shaded surface fₛₕₐ is inferred from the Beer-Lambert relationship with a random orientation of leaves.

$${f}_{sha} = 1 - {e}^{- \frac{Λ}{2}}$$

The albedo is calculated as a function of the leaf area index varying with the seasons and the snow.

a_{canopy}=fₛₕₐa_{veg}+(1−fₛₕₐ)a_{ground}

The vertical distribution of photosynthetically active radiation (PAR) is calculated using the shortwave radiation of the energy module (Block 202):

I=I↑+I↓+Sₛ↓e^{-KΛ}^{_{z}}

Where I↑, I↓, are the diffuse upwards and downwards radiations in the canopy, Sₛ↓ is the incoming radiation on the top of the canopy, K is the optical path of the direct radiation, a function of the distribution of leaves and Λ_{z} is the leaf area index measured from the top of the canopy. The assimilation rate (A) of CO2 is modeled as the minimum rate of carboxylation (Jc) and of electron transfer (Je). The method complements JSBACH with a limitation by the gross photosynthesis rate (Js) limited by the capacity to transport the photosynthetic products for C3 plants and the limited CO2 capacity for C4 plants according to:

A=min{J_{c},Jₑ,Jₛ}

$${J}_{c} = {V}_{m} ( \frac{{C}_{i} - {Γ}_{*}}{{C}_{i} - {K}_{m}} ) ; {J}_{e} = \frac{J}{4} ( \frac{{C}_{i} - {Γ}_{*}}{{C}_{i} - 2 {Γ}_{*}} ) with J = α I \frac{{J}_{m}}{\sqrt{{J}_{m}^{2} + {α}^{2} {I}^{2}}} ;$$

$${J}_{s} = \{ \begin{matrix}0.5 {V}_{m} \\ {2.10}^{4} * {V}_{m} * \frac{{c}_{i}}{p}\end{matrix}$$

where cᵢ is the partial pressure of CO2 in the chloroplast, Γ* the partial pressure of photorespiratory compensation of CO2, Vₘ the maximum photosynthetic rate of Rubisco activity, Kₘ the Michaelis-Menten constant, J the potential rate of electron transport, Jₘ the maximum potential of limited photosynthesis by saturation of light and function of the leaf nitrogen, I the solar radiation penetrating the leaf, and p is the air surface pressure. The Gross Primary Production (GPP), being the amount of carbon fixed by photosynthesis is calculated according to:

GPP=A·Λ

Plants release carbon in the form of autotrophic respiration, being an oxidation of organic compounds in CO2 and H2O.

6CH2O+6O2→6CO2+6H20+energy

The amount of carbon absorbed by plants and incorporated in new plant tissue is called Net Primary Production (NPP) and comprises increments in the biomass of leaves, stems, branches, roots, and reproductive organs. The remaining part is lost by autotrophic respiration (Rₐ) including maintenance (Rₘ) and growth respiration (R_{g}). Rₘ is used to keep the tissues alive and is a function of the leaf area index and the dark respiration. R_{g} is used to synthesize new materials and is correlated with the total growth of plants.

$${R}_{m} = {f}_{leaf}^{- 1} {R}_{dark respiration} \cdot Λ$$

$${CC}_{construction costs} = \frac{NPP + {R}_{g}}{NPP}$$

$$NPP = GPP - {R}_{a} = GPP - {R}_{m} - {R}_{g}$$

Most of the carbon fixed through NPP returns back to the atmosphere through heterotrophic soil respiration (Rₕ) which is the decomposition of organic matter by bacteria and fungi. It is highly dependent on the soil temperature when humidity is available and is calculated using the soil thermal coefficient Q10, by integrating the size of the carbon pool with the humidity α and the turnover time τ at 10° c.

$$\frac{d C}{d t} = - α \cdot {Q}_{10}^{{T}_{sol / 10 ° C .}} \frac{C}{τ}$$

Ecological data suggest that soil respiration and NPP are positively correlated with one another. A high net primary productivity produces more litter, which encourages more decomposition and respiration, promotes mineralization and produces more nitrogen for plant growth. This soil carbon is partitioned into the green pool, the wood pool and the reserve pool with different carbon contents, chemical compositions and compositions in bacteria and fungi according to:

$$\frac{d {C}_{G}}{d t} = {NPP}_{⊳ G} - {F}_{Litter} ( Green pool )$$

$$\frac{d {C}_{W}}{d t} = {NPP}_{⊳ W} - \frac{{C}_{W}}{{τ}_{W}} ( Wood pool )$$

$$\frac{d {C}_{R}}{d t} = {NPP}_{⊳ R} - \frac{{C}_{R}}{{τ}_{R}} ( Reserve pool )$$

These pools release the CO2 in a pool with a short (1 year) and a long (100 years) turnover time, which leads to the calculation of the Net Ecosystems Productivity (NEP) which represents the amount of carbon stored annually in the terrestrial biosphere.

$$\frac{d {C}_{F}}{d t} = \frac{{C}_{R}}{{τ}_{R}} + {F}_{Litter} - {R}_{F} or {R}_{F} = {α}^{k} \cdot {Q}_{10}^{{T}_{sol / 10 ° C .}} \frac{{C}_{F}}{{τ}_{F}} ( Fast pool )$$

$$\frac{d {C}_{S}}{d t} = \frac{{C}_{W}}{{τ}_{W}} + ( 1 - {f}_{F ⊳ A} ) {R}_{F} - {R}_{S} where$$

$${R}_{S} = {α}^{k} \cdot {Q}_{10}^{{T}_{sol / 10 ° C .}} \frac{{C}_{S}}{{τ}_{S}} ( Slow pool )$$

$$NEP = NPP - Rh = A \cdot Λ - {R}_{m} - {R}_{g} - {R}_{F} - {R}_{S}$$

The Net Biosphere Production (NBP) is formalized by integrating the disturbances such as fires and changes due to the use of soils. The fire module (Block 205) takes into account the fires and is integrated in JSBACH. The disturbances related to the anthropogenic use of soils (ALCC, Anthropogenic Land Cover Change) are calculated according to the method of Pongratz (2009) since the last millennium. The manipulations of the land surface are mainly caused by the expansion or the abandonment of agricultural area, including cultivated land and pasture that modify the soil cover and alter the absorption of the biosphere. Urbanization also influences the climate via a growing demand for food and alternative energies (biofuels) of the population, increasing the demand for agricultural areas. Forests, natural grass and shrublands are also affected by this agricultural expansion. The amount of carbon from these disturbances directly emitted into the atmosphere by the three vegetation pools is processed as follows:

$${F}_{⊳ A} = {\sum }_{i ∈ a -} ( {c}_{i}^{old} - {c}_{i}^{new} ) ( {f}_{G ⊳ A} \cdot {C}_{G , i} + {f}_{W ⊳ A} \cdot {C}_{G , i} + {f}_{R ⊳ A} \cdot {C}_{R , i} )$$

Where f_{G} [symbol] _{A}, f_{W} [symbol] _{A}, and f_{R} [symbol] _{A}, are the fractions of ALCC carbon released into the atmosphere function of the three carbon pools (green, wood and reserve), cᵢ^{old}−cᵢ^{new} is the daily variation of change in cover fraction for each functional type of plant that loses its surface area (a−) due to anthropogenic land cover change and C_{G,i}, C_{W,i} and C_{R,i} are the carbon densities in the three pools. For the reallocation of carbon in the fast and slow pools, the carbon from the green and reserve pools is transferred to the fast reservoir, while the carbon from the wood pool is transferred to the slow pool according to:

F [symbol] _{F}=Σ_{iεa-}(cᵢ^{old}−cᵢ^{new})((1−f_{G} [symbol] _{A})·C_{G,i}+(1−f_{R} [symbol] _{A})·C_{R,i}) (Fast pool)

F [symbol] _{S}=Σ_{iεa-}(cᵢ^{old}−cᵢ^{new})(1−f_{W} [symbol] _{A})·C_{W,i} (Slow pool)

The vegetation carbon is lost from a PFT, due to the reduction of its surface, while the carbon densities are not affected. The carbon lost is then transferred to the respective soil carbon pools of the expanding PFT, distributed proportionally to their new cover fractions, and the PFT carbon densities are adjusted accordingly. The leaf area, the autotrophic respiration and the albedo are also modified as a function of the modification in the types of land cover and the vegetation. The NBP represents the net absorption amount over long periods of time by including the disturbances.

F_{bio}(t)=−NBP=−(GPP−Rₐ−Rₕ−disturbances)

The result of the JSBACH module is a mapping of the biosphere fluxes in Kg/m2/s with a 1°×1° grid. The measurement of the in-situ parameters from ecosystem observations (Block 105) enables one to validate the data of the module with real measurements. The ALCC measurements by the satellite observations (Block 101) are integrated in order to validate the change in surface cover. The biosphere flux is calculated back for the initialization to the beginning of the Holocene with a periodicity of 50 years and a global calculation for the planet.

e. Fire Module

Before man had used fires to clear lands and fertilize soils, most of the ecosystems were subject to natural wildfires that led to rejuvenation of old forests and minerals introduction. The fire module is integrated in JSBACH to estimate the disturbances flux F_{fire}(t) related to fires (Block 205, FIG. 9). The results are calculated from the Global Fire Emission Database GFEDv2 of Randerson et al. (2007) and the data is composed of 1°×1° measurements of gridded burned areas, of fuel loads, of combustion efficiency, and of GHGs emissions including the CO2 (Kg/m2/month). After having globally estimated the burned areas, the seasonally changing vegetation, the soil biomass stocks of JSBACH are burned as a function of the burned area estimate and converted into atmospheric GHGs emissions using the estimates of combustion efficiency, of completeness and of fuel loads. The GFEDv2 data are calculated since 1997.

f. Fossil Module

A new fossil module (Block 206, FIG. 9) is integrated in place of the Carbontracker fossil module for measuring the global emissions from fossil fuels production in order to ensure that the whole production is being taken into account. Over the last two centuries, following the industrial revolution and the world population increase, fossil energy combustion has become the largest anthropogenic source of CO2 for notably electricity production, transport, heating and industrial processes. The rate of release of fossil CO2 is calculated by adding the coal and oil contributions from production inventories of the Energy Information Administration (EIA) since 1990:

F_{ff}(t)=F_{coal}(t)+Fₒᵢₗ(t)

Coal is composed of almost 100% of carbon and by considering that almost all this carbon mass enters the atmosphere, the world coal emissions of CO2 are obtained by adding the productions of major producers:

$${F}_{coal} ( t ) \approx Coal production ( million tons / years ) \times \frac{{M}_{CO 2}}{{M}_{C}}$$

Oil is composed of carbon chains with for each carbon atom about 2 attached hydrogen atoms, which represents approximately 86% carbon. Annual world oil production is obtained by summing the daily production in barrels. It should be noted that all carbon is not ejected into the atmosphere and that part of it is used to produce asphalt and resins. However, this non-atmospheric part is likely offset by unreported fossil fuel production, in particular that of unreported coal.

$${F}_{oil} ( t ) \approx Oil production ( million tons / year ) \times 86 \% \times \frac{{M}_{CO 2}}{{M}_{C}}$$

The fossil module data calculation is calculated back from the beginning of the industrial era up to 1800 according to production estimates of Etemad et al. (1991) in order to obtain a measurement of fossil anthropogenic fluxes on a planetary scale on the industrial era in T/year.

### 3. Ascending Inventories Module

Following the modeling of the flux evolution performed by the exchange module, the method for measuring according to the invention then performs a modeling of weekly anthropogenic emissions (FIG. 9, Block 301), or ascending inventories, by means of an ascending inventories module.

These ascending inventories are used as a priori estimates of anthropogenic fluxes and originate from the EDGAR 4.0 model http://edgar.jrc.ec.europa.eu/ of the European Commission, Joint Research Center (JRC) and the Netherlands Environmental Assessment Agency (PBL) (Block 300, FIG. 9). The current and in development spatial distribution of emissions in the data series is performed as a function of reported annual emissions for the 1970-2005 period and include GHGs, acidifying gases and particulates (CO2, CH4, N2O, HFCs, PFCs, SF6, CO, NMVOC, SO2, NOX, NH3, PM2.5, PM10, OC, BC, HCFC, CFC) (FIG. 13). The ascending inventories are determined by using specific data of each country which are organized in regions of the world and the main source categories include: energy, industrial processes, product use, agriculture, land use, land use change and forestry, waste and other anthropogenic sources. The ascending inventories of emissions are calculated for each sector and country with an emission factor based on the technology. The parameters data of the following equation are included for each country/sector combination considered:

Emission(year)=Σ{AD_{c,s}(year)*TECH_{AD,c,s}(year)*EOP_{AD,c,s,TECH}(year)}*EF_{AD,c,s,TECH}*(1−RED_{EOP})

where (x) is the compound, (c) the country, (s) the sector, (year) the year, (AD) the activity data in TJ/year (ex: coal used in a country for heat production), (TECH) the technology, (EOP) the percentage of technologies which are controlled by abatement measures, (EF) the uncontrolled emission factor by sector and technology in KT/TJ and (RED) the percentage reduction of the emission factor uncontrolled by the abatement measure. These data are in part based on the inventory reports, the industry reports, inventory guidance and the scientific literature. The ascending inventories of emissions by country are allocated on a high spatial resolution grid of 0.1°×0.1° (≈100 km²) which can be enlarged to lower resolutions from 0.5°×0.5° to 1°×1° and are integrated into the different resolutions by using the Geographic Information System (GIS) techniques for the conversion, resampling and aggregation. Each spatial grid is linked with the grid of the reference country built on the database of “gridded populations of the world” (GPWv3). The distribution of emissions by sector for each cell of a country is performed according to:

$${F}_{ff} ( x , y , t ) = Emission {( {x}_{i} , {y}_{i} )}_{AD , C , year} = Emission {( C )}_{AD , year} \times \frac{Indicator {( {x}_{i} , {y}_{i} )}_{AD , c , year}}{\sum Indicator {( x , y )}_{AD , c , year}}$$

The (xᵢ, yᵢ) pair represents the lower left corner of each 0.1 grid cell, (AD) the activity data (ex: natural gas of a power plant), (c) the country, (year) the year and the spatial grid indicator. The method models in addition the temporal variability of these inventories (Block 302) according to the Gurney model (2009) for the United States that is extended to the rest of the world with the Gurney equation (2005) before the Gurney seasonalities (2009) are available on a world scale:

$${F}_{i , j , m}^{n} = {F}_{i , j , m}^{o} + {A}_{k} {F}_{i , j , m}^{o} sin {θ}_{j} cos ( \frac{2 π ( m - 1 )}{12} )$$

where F_{i,j,m}ⁿ, is the new flux on each grid cell by using, (i) the longitude index, (j) the latitude index and (m) the index of the month. F_{i,j,m}^{o} is the original flux and (Aₖ) is the amplitude factor, which represents the percentage of increase of the original fossil emissions. These seasonalities permit a temporal decomposition of inventories performed on a weekly basis. The method uses these inventories in the transport module with a 1°×1° resolution in Kg/m2/week and these results are scaled for the current year proportionally to the fossil module totals to obtain the same calibrated basis.

### 4. Transport Module

Following the anthropogenic emissions modeling, the method for measuring according to the invention performs the modeling of the atmospheric transport (FIG. 9, Block 401) by means of a transport module.

The method uses, to simulate winds and the weather, the TM5 transport model described by Krol et al. (2005) driven by the weather forecasts model of the European Center for Medium range Weather Forecast (ECMWF). The CO2 transport in the atmosphere (Block 400, FIG. 9) enables one to link the observations of CO2 from the different layers of the atmosphere (Block 100) to the fluxes of CO2 at the Earth's surface (Block 200, Block 300). The storms, cloud complexes and weather conditions are at the origin of winds that transport CO2 and the influence of emissions, absorptions and local events can have impacts at remote locations. This complex model in 3D simulates the CO2 concentrations in the atmosphere from the fluxes using the weather forecasts fields of the ECMWF. It is an atmospheric zoom model with nested grids of which the regions for which high resolution simulations are desired can be nested in a grid covering the global domain. It has the advantage of performing transport simulations with a regional focus without the need to set boundary conditions such as in other models. This allows the measurements outside the zoomed domain, to constrain the regional fluxes in the data inversion and assimilation, and to ensure that regional estimates are consistent with global constraints.

TM5 operates at 6°×4° horizontal resolution and the zoom goes down to 1°×1° resolution (Europe, North America, South America, Asia, Australia), areas which are nested in 3°×2° regions to ensure a smooth transition between the different domains. The TM5 simulates separately the advection, convection and vertical diffusion in the planetary boundary layer and the troposphere. TM5 runs at a time step of three hours and the processes at finer scales are repeated every 10 minutes (splitting and refined resolution in nested grids). The vertical resolution is 25 hybrids sigma-pressure levels, unevenly spaced with more levels near the surface. The TM5 models the concentrations in ppm/s up to the 1°×1° scale. The in-situ measurement of meteorological parameters by the atmospheric, marine and ecosystems observations (Block 100) enables one to validate the TM5 modeling and to refine its parametrization.

### 5. Data Inversion and Assimilation Module

Based on these modelings, the method for measuring according to the invention then calculates the final fluxes by means of a data inversion and assimilation module (FIG. 14). This module (Block 500, FIG. 14) uses the observations to infer the 1°×1° spatial distribution of terrestrial, oceanic and anthropogenic fluxes. The atmosphere is represented by a state vector representing the net surface-atmosphere flux to determine where λᵣ and λ_{ff} represent a set of linear scalar factors applied to fluxes and estimated each week.

F_{CO2}(x,y,t)=λᵣ·F_{bio}(x,y,t)+λᵣ·F_{oce}(x,y,t)+λ_{ff}·F_{ff}(x,y,t)+F_{fire}(x,y,t)

This module combines a new synthesis inversion (Green function) (Block 501) simple and robust for regional scales analysis (planet, continents, continental regions and countries), followed by the ensemble data assimilation (Block 502) to estimate fluxes with a more precise level of detail on industrialized countries, where the 1°×1° measurements are desired (ex: Europe, America, Asia).

A geographical distribution of the globe surfaces based on the DB1016 decomposition model of Li (1990) is added to aggregate emissions of the 1°×1° grids by regions and countries. The concentration and flux fields are initialized with a mean of estimation in the initial state vector from the equations of the exchange module and their start from the Holocene enables one to obtain a calibrated basis at the time of the first observations. In the inversion and the assimilation, the “a priori” term or “p” is reserved for the fluxes initially created and are fixed, “a” refers to the quantities analyzed during the previous steps, “b” or “background” are the resulting fluxes and contain information progressively drawn from the previous cycles analyzes and “a posteriori” fluxes are the final fluxes. The a priori fluxes are therefore scaled by this module in which the observations are used to infer the a posteriori fluxes. The method defines an optimality criterion with a cost function which is minimized so that the modeling process is comparable to that of the atmosphere on an average scale of time and space. Estimations are progressively refined with observations and the unique values of λᵣ and λ_{ff} result from the smallest least squares difference between observations and modeling.

For the surfaces classification, each λᵣ factor is associated with a particular region (r) of the global domain. The ocean is divided up into 30 major oceanic basins encompassing the circulation features and the biosphere is divided up according to ecosystem types as well as to their geographical location. Each of the 11 TransCom regions of Earth contains a maximum of 19 ecosystems types and the approach leads to a total number of r=11×19+30=239 scaling factors λᵣ optimizable each week on the globe. Even with a single λᵣ parameter available to scale, each 1°×1° grid cell has a different flux F(x,y,t) according to the modeled fluxes mean by the ocean and biosphere modules. The fluxes related to fires are not scaled.

The method adds the λ_{ff} parameter to the Carbontracker in order to scale the results of the ascending inventories module (Block 300). Each λ_{ff} is affixed to the a priori emissions and is optimizable on each 1°×1° grid as a function of the correlation between the observations made and the anthropogenic fluxes of origin. This is motivated by the fact that the geographical distribution of a priori emissions is well known in the ascending inventories module. The exchange module quality and the density of observations with notably the coverage, the resolution and the accuracy of satellites observations, enable to spatially constrain the natural fluxes and to distinguish the anthropogenic component. In addition, analysis of the spatial and temporal variability between individual estimations of flux sources enables one to infer the anthropogenic component which is obtained from the modeled differences between the oceans, the biosphere and fires. The natural fluxes have a greater and correlated variability, whereas the anthropogenic fluxes have weaker variations and are not correlated. Large interannual fluctuations reflect the natural exchanges of terrestrial ecosystems induced by the meteorological and climatic evolutions on a large scale and are not explained by the variability of fossil emissions. These correlations enable one to assess when emissions are linked to anthropogenic or natural sources and the geographical sampling refines this distinction by progressively reducing scales.

In the module, the comparison principle between the observations, the exchange module and the ascending inventories module is the same for the aerial, atmospheric, ecosystem and marine observations, as in the Carbontracker. To compare the concentration observations to fluxes, the TM5 takes an initial distribution of CO2 concentrations and propagates it forward in time by using the weather forecasts while altering the surface concentrations by the fluxes to be optimized. This distribution is then compared at the time and locations of observations. The comparison of flux observations to modeled fluxes is performed such as for Ameriflux in the Carbontracker. The fluxes modeling are integrated at the time and locations of fluxes observations and the inversion and assimilation enables one to minimize the differences between the modeled fluxes and those observed.

The method however adds a modification for the XCO2 satellite data from GOSAT following the method of Feng et al. (2009). The 3D concentration fields are modeled by the TM5 from the exchange module and the ascending inventories module and then integrated at the time and locations of observations for each measurement by using their orbits. Probability Density Functions (PDFs) of clouds and Aerosol Optical Depths (AODs) are derived to retrieve the clear-sky data and the comparison of surface fluxes with the XCO2 data is then performed by applying averaging kernels (Column Averaging Kernels) to take into account the vertical sensitivity of each satellite and map the 1-D CO2 concentration profiles to observed average columns. For the comparison with XCO2 observations from SCIAMACHY, the method is based on Buchwitz et al. (2005a) which enables one on the same principle to obtain average columns by the use of averaging kernels.

Synthesis Inversion (Green Function)

The synthesis inversion is performed following the method of Enting (2002) to optimize emissions from large regions. Only the regional totals are calculated by summing fluxes of 1°×1° grids and the CO2 atmospheric fraction is represented as a linear combination of model runs for the emissions of the different regions and the different weeks. The list of symbols used is the following:

| Symbol | Name | Unit | Dimension |
|---|---|---|---|
| s | State vector | Kg/m2/s | [s] |
| z | A priori estimation vector of s | Kg/m2/s | [s] |
| m | Vector containing the | ppm | [m] |
| | modeled molar fractions | | |
| c | Vector containing observations | ppm | [m] |
| R | Inverse covariance matrix of | (ppm)2 | [m] × [m] |
| | observation data | | |
| P | Inverse covariance matrix | (Kg/m2/s)2 | [s] × [s] |
| | of a priori parameters | | |
| [symbol] | Observation operator (TM5) | ppm → ppm | [m × m] |
| G | Green matrix | Kg/m2/s → ppm | [m × s] |

The general form of the transport equation of CO2 describes the rate of change with time m(r,t), of the modeled atmospheric concentration of CO2 at a point r and at a time t as a function of the local source s(r,t) at each point, and the transport operator H modeling the contribution due to the gas transport from other locations and is subject to specific boundary conditions.

$$\frac{\partial }{\partial t} m ( r , t ) = s ( r , t ) + H [ m ( r , t ) ]$$

It defines a linear relationship between the concentrations m(r,t) and the sources s(r,t) in order to resolve the equation of observed concentrations (c). The solution of this equation by the Green function with specific boundary conditions (t, t′) and (r, r′) is expressed according to:

m(r,t)=mₒ(r,t)+∫d³r′∫G(r,t,r′,t′)s(r′,t′)dt′

where mₒ(r,t) describes the initial state, m(r,t₀), and the solution is calculated to be equivalent to the integration solution of ∂m(r,t)/∂t. The synthesis inversion puts the sources in discrete form in terms of processes μ as unknown scale factors s_{μ}, multiplied by the specified source distribution σ_{μ} (r,t), termed “base functions”:

s_{μ}(r,t)=s_{μ}σ_{μ}(r,t)

This enables one to relate the sources to the exchange module and to the ascending inventories module for each process:

$$\begin{matrix}s ( r , t ) = {\sum }_{μ} {s}_{μ} ( r , t ) \\ = {\sum }_{μ} {s}_{μ} {σ}_{μ} ( r , t ) \\ = {λ}_{r} \cdot {F}_{bio} ( x , y , t ) + {λ}_{r} \cdot {F}_{oce} ( x , y , t ) + \\ {λ}_{ff} \cdot {F}_{ff} ( x , y , t ) + {F}_{fire} ( x , y , t )\end{matrix}$$

Then to the Green function such that:

m(r,t)=Σ_{μ}s_{μ}G_{μ}(r,t)with G_{μ}(r,t)=∫d³r′∫dt′G(r,t,r′,t′)σ_{μ}(r′,t′)

The formal analysis of the Green function is expressed from the generic discrete relationship:

$${c}_{j} = {\sum }_{μ} {G}_{j μ} {s}_{μ} + {ɛ}_{j} = {m}_{j} + {ɛ}_{j}$$

where cⱼ is an item of observed concentration, s_{μ} is the source, mⱼ is the model prediction of concentration for this item, εⱼ is the error in cⱼ and G_{jμ} is a discrete form of G(r,t,r′,t′) relating the concentrations to the sources. For each base function σₘ(r,t), the numerical integration of the transport model will produce a response G_{μ}(r,t). G_{jμ} are the responses for the observation j of a source defined by the distribution σ_{μ}(r,t) and the sources are estimated by using this equation to adjust the coefficients s_{μ} being λᵣ and λ_{ff}. This function which uses the predefined components σ_{μ}(r,t) is called synthesis calculation since the source estimation is synthesized from the predefined components. From these integrations, the specific spatial and temporal values which correspond to each observation j can be extracted to produce the matrix G_{jμ}. For the inversion, the Bayes approach is used, including the knowledge of a priori inventories with the cost function J. The maximum likelihood solution of unknown variables of CO2 fluxes of the state vector s is found by minimizing:

ŝ=[G^{T}RG+P]⁻¹[G^{T}Rc+Pz]

The covariance matrix of ŝ is [G^{T}RG+P]⁻¹ and the results of each base function are compared with the averaged observations at daily values. The solution of the final model is calculated as a linear superposition of models run for the different regions and different weeks. Once finalized, the unique values of λᵣ and λ_{ff} in the state vector are used in the Kalman ensemble assimilation.

Kalman Ensemble Assimilation (EnKF)

Assimilation is performed according to the method of Peters (2005) and progresses with two distinct steps by cycle, that of analysis and that of forecasts. The first is used to find the state of the system that is optimally consistent with the observations and the second describes the evolution in time of this optimal state when new observations are available. From this moment, the forecast state serves as a first guess, or “background” for the next analysis step. These steps are then combined in a complete cycle of assimilation followed by new observations. The list of symbols used is the following:

| Symbol | Name | Unit | Dimension |
|---|---|---|---|
| x | State vector | Kg/m2/s | [s] |
| xᵢ′ | State vector deviations | Kg/m2/s | [s] |
| P | State covariance matrix | (Kg/m2/s)2 | [s × s] |
| X | State deviation matrix | Kg/m2/s | [s × N] |
| y^{o} | Observation vector | ppm | [m] |
| R | Observation-error covariance | ppm2 | [m × m] |
| | matrix | | |
| [symbol] | Observation operator (TM5) | Kg/m2/ | [s] → [m] |
| | | s → ppm | |
| H | Linear observation operator | Kg/m2/ | [s × m] |
| | (matrix) | s → ppm | |
| [symbol] | Dynamic model | Kg/m2/s → | [s] → [s] |
| | | Kg/m2/s | |
| CO2i | Background CO2 | ppm | TM5 grid × N |
| (x, y, z, t) | concentrations | | |

For the first step, the maximum likelihood solution of unknown variables of fluxes of the state vector x is found as a balance of the following cost function (J):

$$J ( x ) = \overbrace{{( y° - H ( x ) )}^{T} {R}^{- 1} ( y° - H ( x ) )}^{Observations} + \overbrace{{( x - {x}^{b} )}^{T} {P}^{- 1} ( x - {x}^{b} )}^{Background parameters}$$

The operator [symbol] which converts the state of the model to the space of observations samples the state vector x and returns a vector [symbol] (x) to compare with observations. The observation vector y^{o} contains the observed CO2 molar fractions less the background ones CO2 (x,y,z,t) in order to account for variations. The state vector x which minimizes J is described by:

xₜ^{a}=xₜ^{b}+K(yₜ^{o}− [symbol] (xₜ^{b}))with Pₜ^{a}=(1−KH)Pₜ^{b}

where H is the linear form of [symbol] , t is the time and K, the Kalman gain matrix, defined by:

K=(Pₜ^{b}H^{T})(HPₜ^{b}H^{T}+R)⁻¹

By creating an ensemble of N CO2 flux fields which has a mean x̅ and that spans the covariance structure P, the optimized fluxes are found by using a set of CO2 observations with the covariance R by running the atmospheric transport model [symbol] , forward N times and sampling it consistently with observations. To create the ensemble statistics, the method extends the number of ensemble members of the Carbontracker to preferably N=300. The covariance structure P describes the magnitude of the uncertainty on each parameter, as well as their correlation in space and the information in P, of background and analyzed, is represented in the dimensions N of an ensemble of state vectors xᵢ composed of a mean state ( x̅) and its deviations (x′ᵢ) such that xᵢ= x̅+x′ᵢ where xᵢ is a function of the λᵣ and λ_{ff} parameters to be optimized. The deviations x′ᵢ are created such that the normalized ensemble of deviations define the columns of the matrix X which is the square root of the covariance matrix P=XX^{T} following:

$$X = \frac{1}{\sqrt{N - 1}} ( {x}_{1} - \overline{x} , {x}_{2} - \overline{x} , … , {x}_{n} - \overline{x} )$$

The ensemble of state vectors defines the Gaussian Probability Density Function (PDF) of x with the covariance P. The Ensemble Square Root Filter (EnSRF) of Carbontracker according to Whitaker et al. (2002) serves to calculate the analyzed ensemble and the batches of observation belonging to one time step of the filter are processed one at a time. K is calculated according to the following approximations:

$${HPH}^{T} \approx \frac{1}{N - 1} ( H ( {x}_{1}^{′} ) , H ( {x}_{2}^{′} ) , … , H ( {x}_{n}^{′} ) ) \cdot {( H ( {x}_{1}^{′} ) , H ( {x}_{2}^{′} ) , … , H ( {x}_{n}^{′} ) )}^{T}$$

$${PH}^{T} \approx \frac{1}{N - 1} ( {x}_{1}^{′} , {x}_{2}^{′} , … , {x}_{n}^{′} ) \cdot {( H ( {x}_{1}^{′} ) , H ( {x}_{2}^{′} ) , … , H ( {x}_{n}^{′} ) )}^{T}$$

Each entry N defines one column of ensemble state vectors or ensemble modeled CO2 values. K linearly maps observed quantities to state vector elements as an average over all the ensemble members. The mean state vector and its deviations are updated according to:

xₜ^{a}=xₜ^{b}+K(yₜ^{o}−H(xₜ^{b}));x′ᵢ^{a}=x′ᵢ^{b}−\tilde{k} [symbol] (x′ᵢ^{b})with

\tilde{k}=K·α=K(1+\sqrt{R/(HP^{b}H^{T}+R)})⁻¹

The analyzed mean and the ensemble state from one observation serve as the background state for the next. They will also go into the calculation of the next observations of the matrix K. The vector of sampled concentrations is updated in a similar way to the state vector by using the ensemble averaged information of K. Each modeled concentration from an observation m to assimilate [symbol] (xₜ)ₘ and its deviations [symbol] (x′ᵢ)ₘ are updated according to:

[symbol]

(xₜ^{a})ₘ= [symbol] (xₜ^{b})ₘ+HₘK(yₜ^{o}− [symbol] (xₜ^{b})ₘ); [symbol] (x′ᵢ^{a})ₘ= [symbol] (x′ᵢ^{b})ₘ−Hₘ\tilde{k} [symbol] (x′ᵢ^{b})

After the update of the ensemble of modeled CO2 values, the algorithm continues with the next observation until all observations are processed to reach the final analyzed ensemble. In the second step, the dynamical model describes the evolution of the state vector in time. It contributes a first guess before new observations are introduced and is applied to the mean of the λᵣ and λ_{ff} values according to:

$${λ}_{r , t}^{b} = \frac{{λ}_{r , t - 2}^{a} + {λ}_{r , t - 1}^{b} + {λ}_{r}^{p}}{3} and {λ}_{ff , t}^{b} = \frac{{λ}_{ff , t - 2}^{a} + {λ}_{ff , t - 1}^{b} + {λ}_{ff}^{p}}{3}$$

The λᵣ and λ_{ff} values for a new time step are chosen as a combination between the optimized values from the two previous time steps and a fixed prior value. This smoothing over three time steps dampens the variations in the forecast of λᵣ and λ_{ff} in time. The inclusion of the prior λλᵣ^{p} and λλ_{ff}^{p} acts as a regularization in order that the parameters revert back to the predetermined value without observations. λλᵣ^{p} and λλ_{ff}^{p} are initialized to 1.

For the assimilation cycles, the state vector contains the flux estimates for several time steps, each corresponding to a one week mean. FIG. 15 presents 3 assimilation cycles with 5 weeks of fluxes composing the state vector indicated by xᵢ (0, . . . , 4), where (0, . . . , 4), defines the number of times when a particular week of fluxes has been estimated on the basis of the observations from previous cycles. i refers to each individual ensemble member and each shaded box represents an ensemble [i=1, . . . , N] of surface fluxes of the globe. Light shaded boxes show the background fluxes and the dark ones, the posterior fluxes, and the cycle runs as follows:
(1) The TM5 is run forward from the initial background concentration fields, from CO2(x,y,z,t) to CO2(x,y,z,t+5) forced by the background fluxes xᵢ (0, . . . , 4). It extracts the CO2 molar fractions at the time and locations of observations in order to construct an ensemble of modeled concentrations at each site.
(2) The equations for the update of the mean state vector and its deviations are solved to give an analyzed ensemble of fluxes for each element of the state vector and each week.
(3) The ensemble of final fluxes in xᵢ^{a} (5) will no longer be estimated in the next cycle. It will be incorporated in CO2i(x,y,z,t+1) by running the TM5 model one week forward starting from CO2i(x,y,z,t) forced with the final ensemble fluxes xᵢ (5).
(4) Each analyzed state vector becomes the background one for the next cycle (light vertical arrows). A new background mean flux is created to go into x̅(0) by propagation with the model [symbol] (dark horizontal arrows).
(5) A new ensemble of N flux deviations x′ᵢ (0) is obtained from the background covariance structure to represent the Gaussian PDF around the new mean flux x̅(0).
(6) New observations y^{o} are read and a new cycle begins.

Once finalized for a year of observation, the final results, in other words the final fluxes, are the optimized values of the λᵣ and λ_{ff} parameters of the state vector with a mapping of natural and anthropogenic fluxes in Kg/week of 1°×1° resolution

### 6. Weighting Module

The method for measuring according to the invention then improves the Carbontracker by adding a new weighting module, which provides the validation that the aggregated results of anthropogenic fluxes faithfully reproduce those of the planet, the continents, the continental regions, the states and the countries and provides an independent verification of the reliability of the scientific data. The module (Block 600, FIG. 16) is based on the game theory in international relations (Luterbacher et al. 2001) and consists in a macro-economic modeling of production activities of economic sectors (energy, industrial processes, product use, agriculture, land use, land use change and forestry, waste and other sources) of each country and its fossil energy use.

In principle, the major part of the world's energy is produced by the combustion of fossil energy and when consumption increases, the CO2 emissions follow, and this is true, even in the countries producing electricity without carbon where fossil energies play an important role in production activities. To calculate the emissions, the production functions represent the value added output of each economic sector by area and include energy and fuel mixes used (coal, oil, natural gas, electricity). The relative price of each fuel modifies the fuel mix used and follows the principle that a more expensive fuel is usually substituted by a cheaper fuel (Block 601) but which does not necessarily reduce emissions if the demand becomes higher in an energy with a higher proportion of carbon. The emission levels are thus defined on the basis of the relative prices of fuels mixes used (Block 602) and of the energy demand of a given production process (Block 603). A seasonality factor modulates the energy consumption in order to obtain the emissions calculated according to the seasonality of the ascending inventories module (Block 604). The corrections related to the energy efficiency are added because the use of energy decreases proportionally to inputs of a production process over time (Block 605). The total energy demand of a production process with the relative prices of fuels defines the fuels mix, the energy used and ultimately the total emissions of the process (Block 606). The aggregation of all processes of a country and the regions gives the total emissions of these areas (Block 607).

A representation of the emissions market in regulated areas such as Europe enables one to account for the effects of technological changes and the reduction of emission levels. These markets are different from conventional trading markets because environmental assets such as the content of carbon in the atmosphere is the same for all. They have independent physical properties from economic institutions because they are public assets which are not rivals in consumption but privately produced. The method performs this representation following the market model of privately produced public goods according to Chichilnisky et al. (2000). The analysis is based upon the equity and efficiency links of these markets and two important factors are taken into account, the emission quotas of each country and the prices of carbon. The supply or the demand for carbon certificates is generated according to the level of the quotas, which sets the prices and induces the technological changes reducing the CO2 (Block 608). The results of the weighting module, the final weighted fluxes, are the emissions totals in TCO2/week. The results of the data inversion and assimilation module are then corrected by modulating the scalar factors λ_{ff} to obtain economic justice for each geographical sub-scale up to the national levels, thereby providing the final weighted fluxes.

### 7. Geocoding Module

The method for measuring according to the invention finally improves the accuracy of the measurements compared to the Carbontracker by also adding a new geocoding module (Block 700, FIG. 17). Once validated, the CO2 fluxes of the 1°×1° grids (Kg/m2/week) and the results of the method are transferred to the geocoding module comprising a GIS coordinate system (Geographic Information System) (Block 702) enabling one to geocode the results and notably, the ascending inventories module data coming from Edgar 4.0 (Block 300) such as the geographic location of energy and manufacturing facilities, road networks, trade routes, the human and animal population densities and the agricultural lands use. The geographical distribution of the surfaces of the globe by countries and regions is also performed according to the decomposition model of Li (1990).

In order to model the fluxes up to the facility scale, the anthropogenic emission inventories of CO2 declared in the EDGAR 4.0 model of the ascending inventories module are distributed spatially by 0.1°×0.1° grid. Then, the method applies proportional correcting coefficients (Block 701) to each of the 0.1°×0.1° grids. These correcting coefficients k_{i,j} are calculated proportionally to the total of each 1°×1° grid obtained from the final weighted fluxes by the weighting module. The coefficients k_{i,j}, are determined linearly on each of the 0.1°×0.1° grids as a function of the CO2 inventories declared by facility and this calculation of proportionality is performed according to the following equation:

$${{F}_{ff} ( x , y )}_{1 ° \times 1 °} = {\sum }_{i = 1}^{10} {\sum }_{j = 1}^{10} {k}_{i , j} \times Emission {( C )}_{AD , year} \times \frac{Indicator {( {x}_{i} , {y}_{i} )}_{AD , c , year}}{\sum Indicator {( x , y )}_{AD , c , year}}$$

In other words, the sum of the inventories corrected by the coefficients of each 0.1°×0.1° grid is equal to the total of the 1°×1° grid obtained from the final weighted fluxes. In the end, the method for measuring according to the invention enables one to correct the results by facility as a function of the scientific observations and to obtain the emissions in Kg/m2/week on 0.1°×0.1° grids (≈100 km2) with an accuracy above 5% and a reduction of uncertain sources related to biases coming from energy consumption, from energy production statistics, from emission factors, from energy consumption ratios and from adjacent source omissions.

In addition, when multiple facilities are present on a 0.1°×0.1° grid, the method calculates the process or combustion emissions from these facilities as a function of their respective activities (energy, industrial processes . . . ) from published data (activity reports, annual reports . . . ) such as currently performed in the ascending methods. The calculation is performed such that the total emissions from these facilities match the total amount corrected of the 0.1°×0.1° grid for the considered period, which enables one to infer the amount for each facility.

### II. Other Greenhouse Gases

As with other methods for measuring, including the Carbontracker, the method adds to the CO2 measurements, those of the CH4, N2O, NOx, HCFC, HFC, CFC, PFC, SF6, O3 and H2O. The exchange module of other greenhouse gases includes specific sources and sinks modeling for each of them with the calculation of the flux following the mass balance. These exchange modules are different from the CO2 and are a function of the sources and sinks mathematically modeled for each GHGs. The measurements of these GHGs are coming from the satellite, aerial, atmospheric, ecosystem and marine observations as presented in the method. The method for measuring according to the invention applies to these GHGs as well as to the CO2 for the obtainment of corrected inventories which are calculated on a weekly basis in Kg/m2 on 0.1°×0.1° grids extrapolated annually. The flux evolution modeling performed by the exchange modules for each of the other GHGs considered are presented below.

Methane CH4

Methane (CH4) is mainly produced through anaerobic processes by natural sources including wetlands, forests, termites, oceans and by anthropogenic sources by the production and combustion of fossil fuels, rice cultivation, livestock, landfills, biomass burning, waste processing and manure.

The method takes into account an additional huge natural source of CH4 since enormous volumes of CH4 are stored under the oceans and in the deep layers of the permafrost under hydrates form where the gas is trapped in crystalline ice cages, which are stable at high pressures and low temperatures. These hydrates represent an important potential energy resource and are generally located in a layer of underground rock or of oceanic sediments called the Hydrate Stability Zone (HSZ). Under the HSZ, the CH4 is found in gaseous phase mixed with water and sediments. When atmospheric temperatures rise, notably with global warming, the HSZ moves upwards, leaving in its place a gas layer released by hydrate destabilization. The pressure in this new layer increases, forcing the gas to go through the HSZ towards the surface through veins and fractures. If the CH4 turns out to be released in massive quantities in this manner, the latter will accelerate global warming by trapping the thermal radiation approximately 25 times more effectively than the CO2 (FIG. 3) and will very certainly become, soon, the major concern that society will have to face. The method uses the essential model of Jain et al. (2009) which models, at the grain scale, how the underground CH4 at the bottom of the oceans escapes through vents in the ocean floor at a pace much faster than expected. It uses a Discrete Element Model (DEM) which enables one to investigate the upward migration of CH4 in its free gas phase and identifies that the main factors controlling the mode of gas transport in the sediments are the grain size and the effective confining stress. Combined with seismic data and samples, the model provides a physical explanation of the recent discovery by the NOAA of a 1400 meter plume coming from the ocean floor of CH4 and hydrates off the Northern California continental margin (Gardner, 2009). The sedimentary conditions in which the migration mechanism of CH4 gas dominate, are permeable in the major part of the ocean, as well as in certain regions of permafrost and this model is used in the method to reproduce the CH4 release from the bottom of the oceans and the permafrost.

The main CH4 atmospheric sink is its tropospheric destruction by hydroxyl radicals (OH) and secondly, it is mainly removed through absorption into the soil with oxidation by bacteria and transport to the stratosphere where it reacts with OH, Cl and O(¹D). Its lifetime τ_{CH4}, is calculated by its reaction with the hydroxyl radicals OH with τ_{OH}=1/(k₁∞[OH]) where k1 is the reaction coefficient, [OH] the concentration and τ_{additional} defines its lifetime as a function of the other additional minor sinks according to:

1/τ_{CH4}=1/τ_{OH}+1/τ_{additional}

The flux is expressed according to the following equation:

F_{CH4}(t)=F_{A}(t)+F_{bio}(t)+F_{oce}(t)+Fₚₑᵣ(t)+F_{fire}(t)−C_{CH4}(t)·L(t)
F_{CH4}(t) is the net accumulated atmospheric flux
F_{A}(t) is the net anthropogenic sources flux
F_{bio}(t) is the net atmosphere-biosphere exchanges flux
F_{oce}(t) is the net CH4 hydrate flux from the oceans
Fₚₑᵣ(t) is the net CH4 hydrate flux from the permafrost
F_{fire}(t) is the net flux from sources related to fires
C_{CH4}(t) is the atmospheric concentration
L(t) is the average loss rate in the atmosphere as a function of the lifetime 1/τ_{CH4}.

Nitrous Oxide (N2O)

The nitrous oxide (N2O) is mainly produced by anthropogenic sources (nitrogen fertilizers, industrial processes, transport, biomass burning, fossil energy combustion, cattle feed lots) and by natural biological mechanisms in the oceans and soils. The main N2O sink is its destruction by photochemical reactions in the stratosphere involving the production of nitrogen oxides and secondly, the denitrification by soil bacteria.

F_{N2O}(t)=F_{A}(t)F_{bio}(t)F_{oce}(t)+F_{fire}(t)−C_{N2O}(t)·L(t)
F_{N2O}(t) is the net accumulated atmospheric flux
F_{A}(t) is the net anthropogenic source flux
F_{bio}(t) is the net atmosphere-biosphere exchange flux
F_{oce}(t) is the net atmosphere-ocean exchange flux
F_{fire}(t) is the net flux from sources related to fires
C_{N2O}(t) is the atmospheric concentration
L(t) is the average loss rate in the atmosphere as a function of the lifetime 1/τ_{N2O}.

Nitrogen Oxides (NOx=NO+NO2)

The nitrogen oxides (NOx=NO+NO2) are mainly produced by the combustion of fossil energy, biomass burning, emissions from soils, lightning, oxidation of ammonia and air traffic. The main sink of NOx is its oxidation in the atmosphere and important amounts arising from soils are used up in the canopy before escaping to the troposphere. NOx are also absorbed by dry deposition on soils, such deposition can then lead to N2O emissions. They act as indirect GHGs by producing the tropospheric O3 via photochemical reactions in the atmosphere. They also have an effect on the abundance of OH radicals because their destruction gives rise to an increase in OH, reducing the lifetime of some GHGs such as CH4.

F_{Nox}(t)=F_{A}(t)F_{bio}(t)F_{fire}(t)−C_{NOx}(t)·L(t)
F_{NOx}(t) is the net accumulated atmospheric flux
F_{A}(t) is the net anthropogenic source flux
F_{bio}(t) is the net atmosphere-biosphere exchange flux
F_{fire}(t) is the net flux from sources related to fires
C_{Nox}(t) is the atmospheric concentration
L(t) is the average loss rate in the atmosphere as a function of the lifetime 1/τ_{NOx}.

Chlorofluorocarbons CFC

Chlorofluorocarbons CFC are anthropogenically produced (aerosol propellants, refrigerants, cleansers, air conditioners, fire suppression systems, manufacturing processes). These molecules slowly rise in the stratosphere and move poleward where they are decomposed by photochemical processes and they destroy stratospheric ozone.

F_{CFC}(t)=F_{A}(t)−C_{CFC}(t)·L(t)
F_{CFC}(t) is the net accumulated atmospheric flux
F_{A}(t) is the net anthropogenic source flux
C_{CFC}(t) is the atmospheric concentration
L(t) is the average loss rate in the atmosphere as a function of the lifetime 1/τ_{CFC}.

Hydrofluorocarbons HFC and Hydrochlorofluorocarbons HCFC

Hydrofluorocarbons HFC, and hydrochlorofluorocarbons HCFC are anthropogenically produced (aerosol propellants, refrigerants, cleansers, air conditioners, fire suppression systems, manufacturing processes, insulation, packaging) usually with a lifetime of a few years and significant greenhouse gases effects. They react with OH in the troposphere.

F_{HFC}(t)=F_{A}(t)−C_{HFC}(t)·L(t)

F_{HCFC}(t)=F_{A}(t)−C_{HCFC}(t)·L(t)
F_{HFC}(t), F_{HCFC}(t) is the net accumulated atmospheric flux
F_{A}(t) is the net flux of the respective anthropogenic sources
C_{HFC}(t), C_{HCFC}(t) is the atmospheric concentration
L(t) is the average loss rate in the atmosphere as a function of their respective lifetimes 1/τ_{HFC}, 1/τ_{HCFC}.

Perfluorocarbons PFC

The perfluorocarbons PFC are almost entirely anthropogenic

GHGs (aluminum production, production of trifluoroacetic or TFA, semi-conductor manufacturing) and are also coming from natural sources (fluorites). An important sink is the light destruction (photolysis) or ionic reactions in the mesosphere.

F_{PFC}(t)=F_{A}(t)F_{bio}(t)−C_{PFC}(t)·L(t)
F_{PFC}(t) is the net accumulated atmospheric flux
F_{A}(t) is the net anthropogenic source flux
F_{bio}(t) is the net atmosphere-biosphere exchange flux
C_{PFC}(t) is the atmospheric concentration
L(t) is the average loss rate in the atmosphere as a function of the lifetime 1/τ_{PFC}.

Sulphur Hexafluoride (SF6)

Sulfur hexafluoride (SF6) is an almost entirely anthropogenic GHG (magnesium production, high voltage circuit breakers and switchgears manufacturing, semi-conductors, solvents, use in tires) and is also coming from natural sources (fluorites). The only known sink is the light destruction (photolysis) or ionic reactions in the mesosphere. The SF6 is a powerful GHG and due to its high density compared to the air, it stays at the bottom of the atmosphere, this limiting its global warming ability. An important sink is the light destruction (photolysis) or ionic reactions in the mesosphere.

F_{SF6}(t)=F_{A}(t)F_{bio}(t)−C_{SF6}(t)·L(t)
F_{SF6}(t) is the net accumulated atmospheric flux
F_{A}(t) is the net anthropogenic source flux
F_{bio}(t) is the net atmosphere-biosphere exchange flux
C_{SF6}(t) is the atmospheric concentration
L(t) is the average loss rate in the atmosphere as a function of the lifetime 1/τ_{SF6}.

Tropospheric Ozone (O3)

The tropospheric ozone (O3) is mainly coming from the stratosphere and is also produced in the troposphere by photochemical reactions where its concentrations increase in relation with high levels of air pollutants from anthropogenic sources (biomass burning, industry, transport). The dominant photochemical sinks of tropospheric ozone are the catalytic destruction cycle including the HO2+O3 reaction and the photolytic destruction involving the reaction of O(¹D), a product of ozone photodissociation. Another important sink is the absorption by plants. It also acts as an indirect GHG because its decomposition by sunlight produces OH radicals.

F_{O3}(t)=F_{A}(t)+F_{bio}(t)−C_{O3}(t)·L(t)
F_{O3}(t) is the net accumulated atmospheric flux
F_{A}(t) is the net anthropogenic source flux
F_{bio}(t) is the net atmosphere-biosphere exchange flux
C_{O3}(t) is the atmospheric concentration
L(t) is the average loss rate in the atmosphere as a function of the lifetime 1/τ_{O3}.

Water Vapor (H2O)

Water vapor (H2O) is function of the temperature, influenced by the climate. In the stratosphere, it is mainly coming from the oxidation of CH4, air traffic increase, tropospheric water vapor residues and in the troposphere, it mainly comes from evaporation and transpiration of the vegetation and oceans and it is lost by condensation and precipitation. It is also a result of anthropogenic sources, from industry, homes and transport. The water vapor, especially stratospheric, acts as a powerful GHG because a higher concentration of water vapor absorbs more thermal IR energy radiated by the earth and warms the atmosphere. The tropospheric water vapor is expressed by:

F_{H2O}(t)=F_{A}(t)+F_{bio}(t)+F_{oce}(t)−C_{H2O}(t)·L(t)
F_{H2O}(t) is the net accumulated atmospheric flux
F_{A}(t) is the net anthropogenic source flux
F_{bio}(t) is the net atmosphere-biosphere exchange flux
F_{oce}(t) is the net atmosphere-ocean exchange flux
C_{H2O}(t) is the atmospheric concentration
L(t) is the average loss rate in the atmosphere as a function of the lifetime 1/τ_{H2O}.

The stratospheric water vapor is expressed by:

F_{H2O}(t)=F_{A}(t)+F_{T}(t)−C_{H2O}(t)·L(t)
F_{H2O}(t) is the net accumulated atmospheric flux
F_{A}(t) is the net anthropogenic source flux
F_{T}(t) is the net flux coming from tropospheric water vapor residues
C_{H2O}(t) is the atmospheric concentration
L(t) is the average loss rate in the atmosphere as a function of the lifetime 1/τ_{H2O}.

Carbon Monoxyde (CO)

Carbon monoxide (CO) comes from the chemical oxidation of CH4 and other hydrocarbons in the atmosphere, from transport, fossil energy combustion, biomass burning and natural sources, and from vegetation and the oceans. The sinks of CO are essentially its reaction with OH, as well as its deposition on the ground. It has important indirect GHGs effects by reacting with OH radicals in the atmosphere and also leads to the formation of tropospheric ozone.

F_{CO}(t)=F_{A}(t)+F_{bio}(t)+F_{oce}(t)+F_{fire}(t)−C_{CO}(t)·L(t)
F_{CO}(t) is the net accumulated atmospheric flux
F_{A}(t) is the net anthropogenic source flux
F_{bio}(t) is the net atmosphere-biosphere exchange flux
F_{oce}(t) is the net atmosphere-ocean exchange flux
F_{fire}(t) is the net flux from sources related to fires
C_{CO}(t) is the atmospheric concentration
L(t) is the average loss rate in the atmosphere as a function of the lifetime 1/τ_{CO}.

Dihydrogen (H2)

Dihydrogen (H2) is produced by the oxidation of CH4 and mainly by fossil energy combustion. The future evolution of electricity generation by hydrogen will potentially lead to a strong increase in its emissions. The H2 sinks are essentially its removal by the reaction with OH and the absorption by soil microorganisms. It is also an indirect GHG by reacting with the (OH) radicals.

F_{H2}(t)=F_{A}(t)+F_{bio}(t)+F_{fire}(t)−C_{H2}(t)·L(t)
F_{H2}(t) is the net accumulated atmospheric flux
F_{A}(t) is the net anthropogenic source flux
F_{bio}(t) is the net atmosphere-biosphere exchange flux
F_{fire}(t) is the net flux from sources related to fires
C_{H2}(t) is the atmospheric concentration
L(t) is the average loss rate in the atmosphere as a function of the lifetime 1/τ_{H2}.

### III. Measuring System

According to the invention, the method for measuring is implemented by means of a data processing system (FIG. 18, Block 800) comprising means for measuring greenhouse gas concentrations and fluxes as described above (satellites, aircraft, atmospheric measurement stations, marine measurement stations, ships and/or ecosystem measurement stations, sensors, ecosystem sensors, marine sensors), at least one centralized database comprising the observation module, means for extracting, comprising means for transferring automated data, and also ensuring the necessary interface with the communication networks. The measuring system according to the invention also comprises means for calculating such as a plurality of dedicated information servers, computers, mainframes, etc. The measuring system comprises, in addition means for reporting, one or more graphical interfaces and one or more interfaces for facilities control. As has been said above, each of the modules of the method can advantageously be implemented in the form of software, hardware or a combination of both. In addition, given the relative complexity of the method for measuring according to the invention, it is clear that the measuring system which implements it requires strong computing power, important data storage capacity as well as reliable and fast means for communicating.

As stated above, the invention therefore aims to provide refined measurements of GHGs emissions for a given geographical area, and does this by executing the method for measuring according to the invention. These refined measurements can then either constitute the final result intended to be taken into consideration by individual or institutional users, or directly be used for the technical control of industrial facilities.

In the first case, a centralized internet platform then enables one to view and analyze the greenhouse gases emissions of a plurality of given geographical areas covering the entire globe. The measurements performed and the results are continuously transmitted, preferably in real time, to this Internet platform. Users of the system can advantageously put in place several axes of analysis including, but not limited to types of GHGs, coordinates (latitude, longitude), values of fluxes, time, uncertainty as well as the fields of results of the observation module, the exchange module, the ascending inventories module, the transport module, the inversion and assimilation module, the weighting module and the geocoding module to perform detailed analyses.

The platform is accessible by Internet to users equipped with a personal computer or similar connected equipment, and this, preferably with a secured access via a graphical interface. This interface enables users to navigate on the map throughout these grids by scaling them such as “GoogleEarth” and to view the fluxes evolution in real time. The access rights to data are allocated as a function of user profiles and can be limited geographically in order to preserve the confidentiality of inventories (Block 806).

Reporting can be performed as a function of the desired geographical area (world, continents, states, countries, regions and facilities), the desired time period (year, month, week) and the types of GHGs. The user then selects the desired anthropogenic sources or groups of sources which are geocoded on the map and the system aggregates the sum of the fluxes in the area and the time period considered. GHGs inventories reports, intended for facility operators, can be generated at any time. They preferably include the inventories of the different types of GHGs, the details of the measurements performed with the type of observation, accuracy, resolution and continuity as well as updated statistics on historical levels, current levels and trends. The results are in TCO2/year, and then in TCO2 eq/year after having applied the method to the other GHGs and obtained the TGHGs/year (Block 807).

The system provides in situ observations with a near real-time mapping of GHGs sources and sinks at the global, continental, state, national, local scales up to the level of the facilities to reflect the reality of emissions levels.

An intended use is to provide this access to data to facility operators, who desire to voluntarily, or if they are regulated, measure and manage their GHGs inventories. The accuracy, the continuity and the uniformity of measurements, enables them to complement the current monitoring, reporting and verification (MRV) processes performed by private verifiers notably those accredited by the European Commission on the EU-ETS emissions market. Operators can by means of the system, access, view, and obtain detailed reports on the local GHGs sources and sinks related to their facilities in order to continuously verify the evolution of levels and verify the effectiveness of mitigation technologies being setup. The system also enables those regulated on the emissions markets, to plan their GHGs budgets, as a function of their current inventories, the price evolution of the GHGs permits traded on the markets and to assess the emission credits which they will need each year to remain in compliance with the authorities.

In the other case, the measuring system according to the invention can also be interfaced directly within an emitting facility, notably with a production management system, to enable the control of the facility in order to limit the combustion and/or process emissions and automate their reduction.

Specific software is installed by facility as a function of its activity (energy, industrial processes, product uses . . . ), on its processes and the GHGs emitted. The measuring system according to the invention then enables one to calibrate and to directly optimize the process of each facility as a function of the levels and types of measured emissions (ex: pollution peaks). This enables one to obtain an automated emission reduction on each facility, to progressively control in time its effectiveness and to remain in compliance with regulatory and environmental standards.

As an example, in the energy field, facilities are looking for ways enabling one to preserve the air quality while operating more productive units. In a coal-fired power plant, the more the burning and the production of electricity increase, the higher the emissions of CO2, NOx and CO are released. By interfacing then the measuring system according to the invention with software enabling one to automate the electricity production processes, one can then optimize the ratio between emission reduction and burner efficiency. Software transmitting operating parameters to different locations of the power plant to a main control computer and others, interfaced with the measuring system according to the invention, optimize the combustion by adjusting the air and fuel fluxes in the burners, thus stabilizing the GHGs levels. Interfaced with the production management system of a coal-fired power plant, the system precisely identifies and quantifies the types of emitted gases (CO2, CH4, N2O, NOx, HFC, HCFC, CFC, PFC, SF6, O3, H20, CO, H2) and then controls and optimizes by means of ad-hoc software the electricity production processes by influencing, for example, the ratio between emission reduction and burner efficiency.

A person skilled in the art knows how to adapt the necessary interfaces between the measuring system according to the present invention and the control systems of production facilities.

1. Method for measuring weekly and annual emissions of a greenhouse gas generated over a determined geographical area, wherein it includes the following steps:
perform daily concentration measurements of said greenhouse gas in a first plurality of locations distributed on the entire terrestrial globe and save said daily concentration measurements in an observation module,
perform daily flux measurements of said greenhouse gas in a second plurality of locations distributed on the entire globe, and save the said daily flux measurements in said observation module,
perform measurements of satellite parameters, meteorological parameters, marine parameters and ecosystem parameters in a third plurality of locations distributed on the terrestrial globe and save said parameter measurements in the said observation module,
extract, by means of an extraction module, the weather forecast data from at least one data source,
perform a flux evolution modeling of the said gas on the globe by means of an exchange module modeling the natural and anthropogenic sources and sinks,
perform a weekly anthropogenic emissions modeling of said greenhouse gas by means of an ascending inventories module, said module integrating the raw data of emissions for a plurality of facilities,
perform, using said flux evolution modeling, said weekly anthropogenic emissions modeling, and said weather forecast data, an atmospheric transport modeling of the said greenhouse gas by means of a transport module,
calculate the final fluxes of said greenhouse gas, by means of a data inversion and assimilation module using said fluxes modeling performed by the exchange module, said weekly anthropogenic emissions modeling performed by the ascending inventories module, said atmospheric transport modeling performed by the transport module and said measurements saved in said observation module,
weight, by means of a weighting module, the said final fluxes so as to provide final weighted fluxes,
calculate, using said final weighted fluxes and said weekly anthropogenic emissions modeling performed by the ascending inventories module, the weekly emissions of said greenhouse gas of said geographical area, by means of a geocoding module comprising at least one geographic information system,
extrapolate, from said weekly emissions, the annual emissions of said greenhouse gas of the said geographical area.

2. Method for measuring according to claim 1, wherein the surface of the said geographical area is between 1 km2 and 10,000 km2, in particular that said geographical area includes at least one given anthropogenic source.

3. Method for measuring according to claim 1, wherein said greenhouse gas is selected from the group consisting of: carbon dioxide (CO2), methane (CH4), nitrous oxide (N2O), nitrogen oxides (NOx), hydrofluorocarbons (HFC), hydrochlorofluorocarbons (HCFC), chlorofluorocarbons (CFC), perfluorocarbons (PFC), sulfur hexafluoride (SF6), ozone (O3), water vapor (H2O), carbon monoxide (CO) and dihydrogen (H2).

4. Method for measuring according to claim 1, wherein said daily concentration measurements of said greenhouse gas on the globe, said daily flux measurements of the said greenhouse gas on the globe, said measurements of satellite parameters, meteorological parameters, marine parameters and ecosystem parameters are performed by means of a plurality of satellites, aircraft, atmospheric measurement stations, marine measurement stations, ships and/or ecosystem measurement stations enabling one to perform measurements on the entire globe.

5. Method for measuring according to claim 1, wherein said exchange module performs said flux evolution modeling of the said greenhouse gas, from the Holocene, using a solar module modeling the solar radiation using the orbital parameters of the terrestrial geometry with a calculation of the eccentricity of the Earth determined proportionally to the eccentricity of Mars.

6. Method for measuring according to claim 1, wherein said exchange module performs said flux evolution modeling of said greenhouse gas, from the Holocene, using an energy module modeling the shortwave radiation, by including reflectivity, absorptivity and transmissivity of the atmosphere, absorption by the greenhouse gases and clouds, variations of planetary albedo and influence of the ozone layer hole, the said energy module modeling also the longwave radiation, using the Schwartzschild equation, the method of the emissivities and including the absorption and emission by the greenhouse gases and the clouds of longwave radiation, latent heat fluxes, sensible heat fluxes, conduction fluxes and surface temperature.

7. Method for measuring according to claim 1, wherein said exchange module performs said flux evolution modeling of said greenhouse gas, from the Holocene, using an ocean module modeling the net effect of atmosphere-ocean exchanges on the basis of the MOM3 model combined with said weather forecast data and taking into account the buffer effect, the absorption by chemical weathering following the CDIAC DB1012 model and the release by evaporation.

8. Method for measuring according to claim 1, wherein said exchange module performs the flux evolution modeling of said greenhouse gas, from the Holocene, using a biosphere module modeling the net effect of atmosphere-biosphere exchanges on the basis of the JSBACH model and including the plant types of the biosphere, the leaf area index, the light, the albedo, the C3 and C4 photosynthesis, the addition of the limited gross photosynthetic rate, autotrophic respiration, heterotrophic respiration and/or anthropogenic modification of the land cover since at least the last millennium.

9. Method for measuring according to claim 8, wherein said biosphere module uses a fire module modeling the disturbances due to fires on the basis of the data extracted from the Global Fire Emission Database (GFEDv2) integrated in the JSBACH model.

10. Method for measuring according to claim 1, wherein said exchange module performs said flux evolution modeling of said greenhouse gas, from the Holocene, using a fossil module modeling the fossil anthropogenic emissions on a global scale on the basis of the oil and coal production statistics of the Energy Information Administration (EIA) and the estimates of Etemad et al.

11. Method for measuring according to claim 1, wherein said ascending inventories module extracts emission inventories from the EDGAR 4.0 database and includes a calculation of the temporal variability of emissions.

12. Method for measuring according to claim 1, wherein the said atmospheric transport module uses the TM5 transport model combined with said weather forecast data to calculate the flux atmospheric transport of said greenhouse gas on the globe.

13. Method for measuring according to claim 1, wherein said data inversion and assimilation module uses, to calculate said final fluxes, a synthesis inversion with the Green function for the large regions and the ensemble Kalman filter.

14. Method for measuring according to claim 1, wherein said weighting module uses, to weight the said final fluxes, an analysis of the production activities of countries and regions of the world together with a modeling of emission markets based on the model of privately produced public goods.

15. Method for measuring according to claim 1, wherein said geocoding module uses correcting coefficients.

16. Measuring system for implementing the method according to claim 1 comprising
means for measuring (801) concentrations and fluxes of greenhouse gases,
means for measuring (801) satellite, meteorological, marine and ecosystem parameters,
at least one centralized database (803) comprising an observation module,
means for extracting (802) and transferring automated data,
means for calculating (805) comprising at least one exchange module, at least one ascending inventories module, at least one transport module, at least one data inversion and assimilation module, and at least one weighting module,
at least one geocoding module (804) comprising a geographic information system enabling one to geocode the results provided by the said means for calculating,
one centralized Internet platform enabling one to view and analyze the greenhouse gas emissions of a plurality of given geographical areas.

17. Measuring system according to claim 16, wherein it comprises means for interfacing (808) with a production management system of a facility.
